(19) United States
(12) Patent Application Publication
(10) Pub. No.: US 2009/0245577 A1
(43) Pub. Date: Oct. 1, 2009

(54) Tracking Processing Apparatus, Tracking Processing Method, and Computer Program

(76) Inventors: Yuyu LIU, Tokyo (JP); Keisuke YAMAOKA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/410,797

(22) Filed: Mar. 25, 2009

(30) Foreign Application Priority Data
Mar. 28, 2008 (JP) P2008-087321

(51) Int. Cl. G06K 9/00

(52) U.S. Cl. 382/103

(57) ABSTRACT

A tracking processing apparatus includes: first state-variable-sample-candidate generating means for generating state variable sample candidates at first present time; plural detecting means each for performing detection concerning a predetermined detection target related to a tracking target; sub-information generating means for generating sub-state variable probability distribution information at present time; second state-variable-sample-candidate generating means for generating state variable sample candidates at second present time; a state-variable-sample acquiring means for selecting state variable samples out of the state variable sample candidates at the first present time and the state variable sample candidates at the second present time at random according to a predetermined selection ratio set in advance; and estimation-result generating means for generating main state variable probability distribution information at the present time as an estimation result.

### CROSS-REFERENCES TO RELATED APPLICATIONS

The present invention contains subject matter related to Japanese Patent Application JP 2008-087321 filed in the Japanese Patent Office on Mar. 28, 2008, the entire contents of which being incorporated herein by reference.

### BACKGROUND OF THE INVENTION

1. Field of the Invention

The present invention relates to a tracking processing apparatus that tracks a specific object as a target, a method for the tracking processing apparatus, and a computer program executed by the tracking processing apparatus.

2. Description of the Related Art

There is known various methods and algorithms of tracking processing for tracking the movement of a specific object. For example, a method of tracking processing called ICondensation is described in M. Isard and A. Blake, “ICondensation: Unifying low-level and high-level tracking in a stochastic framework”, In Proc. of 5th European Conf. Computer Vision (ECCV), vol. 1, pp. 893-908, 1998 (Non-Patent Document 1).

JP-A-2007-333690 (Patent Document 1) also discloses the related art.

### SUMMARY OF the INVENTION

Therefore, it is desirable to obtain an apparatus and a method for tracking processing that are more accurate and robust and have higher performance than those proposed in the past.

According to an embodiment of the present invention, there is provided a tracking processing apparatus including: first state-variable-sample-candidate generating means for generating state variable sample candidates at first present time on the basis of main state variable probability distribution information at preceding time; plural detecting means each for performing detection concerning a predetermined detection target related to a tracking target; sub-information generating means for generating sub-state variable probability distribution information at present time on the basis of detection information obtained by the plural detecting means; second state-variable-sample-candidate generating means for generating state variable sample candidates at second present time on the basis of the sub-state variable probability distribution information at the present time; state-variable-sample acquiring means for selecting state variable samples out of the state variable sample candidates at the first present time and the state variable sample candidates at the second present time at random according to a predetermined selection ratio set in advance; and estimation-result generating means for generating main state variable probability distribution information at the present time as an estimation result on the basis of likelihood calculated on the basis of the state variable samples and an observation value at the present time.

In the tracking processing apparatus according to the embodiment, as tracking processing, the main state variable probability distribution information at the preceding time and the sub-state variable probability distribution information at the present time are integrated to obtain the estimation result (the main state variable probability distribution information at the present time, concerning the tracking target. In generating the sub-state variable probability distribution information at the present time, plural kinds of detection information are introduced. Consequently, compared with generating sub-state variable probability distribution information at the present time according to only single kind of detection information, accuracy of the sub-state variable probability distribution information at the present time is improved.

According to the embodiment, higher accuracy and robustness are given to the estimation result of the tracking processing. As a result, tracking processing with more excellent performance can be performed.

### BRIEF DESCRIPTION OF THE DRAWINGS

FIG. 1 is a diagram of a configuration example of an integrated tracking system according to an embodiment of the present invention;

FIG. 2 is conceptual diagram for explaining a probability distribution represented by weighting a sample set on the basis of the Monte-Carlo method;

FIG. 3 is a flowchart of a flow of processing performed by an integrated-tracking processing unit;

FIG. 4 is a schematic diagram of the flow of the processing shown in FIG. 3 mainly as state transition of samples;

FIGS. 5A and 5B are diagrams of a configuration example of a sub-state-variable-distribution output unit in the integrated tracking system according to the embodiment;

FIG. 6 is a schematic diagram of a configuration for calculating a weighting coefficient from reliability of detection information in a detecting unit in the sub-state-variable-distribution output unit according to the embodiment;

FIG. 7 is a diagram of another configuration example of the integrated tracking system according to the embodiment;

FIG. 8 is a flowchart of a flow of processing performed by an integrated-tracking processing unit shown in FIG. 7;

FIG. 9 is a diagram of a configuration example of the integrated tracking system according to the embodiment applied to person posture tracking;

FIG. 10 is a diagram of a configuration example of the integrated tracking system according to the embodiment applied to person movement tracking;

FIG. 11 is a diagram of a configuration example of the integrated tracking system according to the embodiment applied to vehicle tracking;

FIG. 12 is a diagram of a configuration example of the integrated tracking system according to the embodiment applied to flying object tracking;

FIGS. 13A to 13E are diagrams for explaining an overview of three-dimensional body tracking;

FIG. 14 is a diagram for explaining a spiral motion of a rigid body;

FIG. 15 a diagram of a configuration example of a detecting unit for the three-dimensional body tracking according to the embodiment;

FIG. 16 is a flowchart of three-dimensional body image generation processing; and

FIG. 17 is a block diagram of a configuration example of a computer apparatus.

### DESCRIPTION OF THE PREFERRED EMBODIMENTS

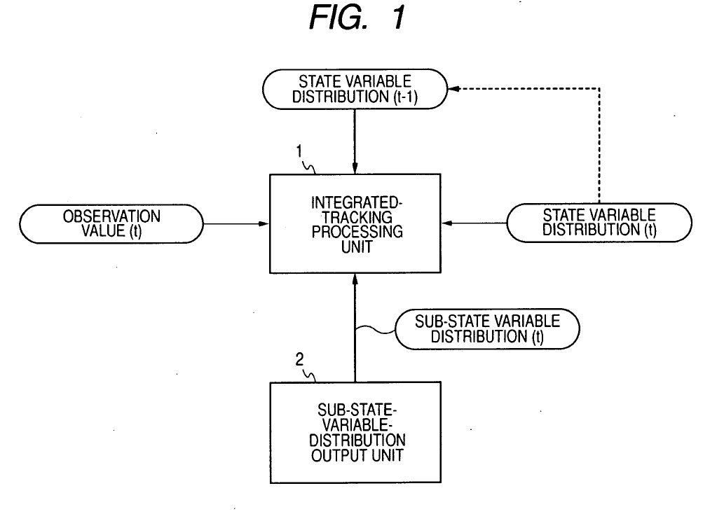

FIG. 1 is a diagram of a system for tracking processing (a tracking system) as a premise of an embodiment of the present invention (hereinafter referred to as embodiment). This tracking processing system is based on a tracking algorithm called ICondensation (an ICondensation method) described in Non-Patent Document 1.

The tracking system shown in FIG. 1 includes an integrated-tracking processing unit 1 and a sub-state-variable-distribution output unit 2.

As a basic operation, the integrated-tracking processing unit 1 can obtain, as an estimation result, a state variable distribution (t) (main state variable probability distribution information at present time) at time “t” according to tracking processing conforming to a tracking algorithm of Condensation (a condensation method) on the basis of an observation value (t) at time “t” (the present time) and a state variable distribution (t−1) at time t−1 (preceding time) (main state variable probability distribution information at the preceding time). The state variable distribution means a probability distribution concerning a state variable.

The sub-state-variable-distribution output unit 2 generates a sub-state variable distribution (t) (sub-state variable probability distribution information at the present time), which is a state variable distribution at time “t” estimated for a predetermined target related to the state variable distribution (t) as the estimation result on the integrated-tracking processing unit 1 side, and outputs the sub-state variable distribution (t).

In general, a system including the integrated-tracking processing unit 1 that can perform tracking processing based on Condensation and a system actually applied as the sub-state-variable-distribution output unit 2 can obtain the state variable distribution (t) concerning the same target independently from each other. However, in ICondensation, the state variable distribution (t) as a final processing result is calculated by integrating, mainly using tracking processing based on Condensation, a state variable distribution at time “t” obtained on the basis of Condensation and a state variable distribution at time “t” obtained by another system. In other words, in relation to FIG. 1, the integrated-tracking processing unit 1 calculates a final state variable distribution (t) by integrating a state variable distribution (t) internally calculated by the tracking processing based on Condensation and a sub-state variable distribution (t) obtained by the sub-state-variable-distribution output unit 2 and outputs the final state variable distribution (t).

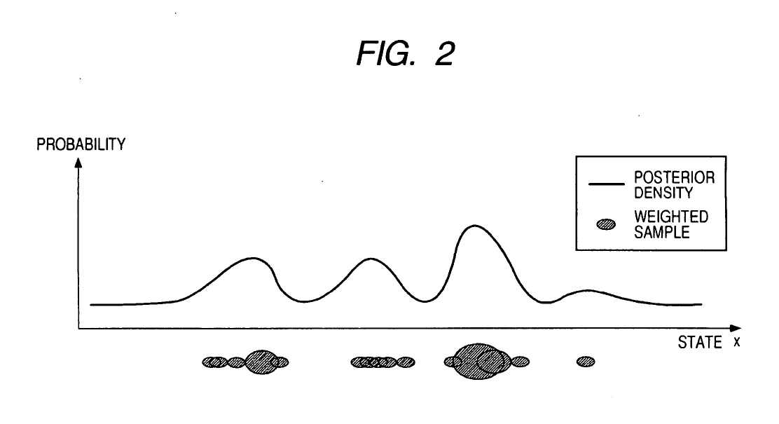

The state variable distribution (t−1) and the state variable distribution (t) treated by the integrated-tracking processing unit 1 shown in FIG. 1 are probability distributions represented by weighting a sample group (a sample set) on the basis of the Monte-Carlo method according to, for example, Condensation and ICondensation. This concept is shown in FIG. 2. In this figure, a one-dimensional probability distribution is shown. However, the probability distribution can be expanded to a multi-dimensional probability distribution.

Centers of spots shown in FIG. 2 are sample points. A set of these samples (a sample set) is obtained as samples generated at random from a prior density. The respective samples are weighted according to observation values. Values of the weighting are represented by sizes of the spots in the figure. A posterior density is calculated on the basis of the sample group weighted in this way.

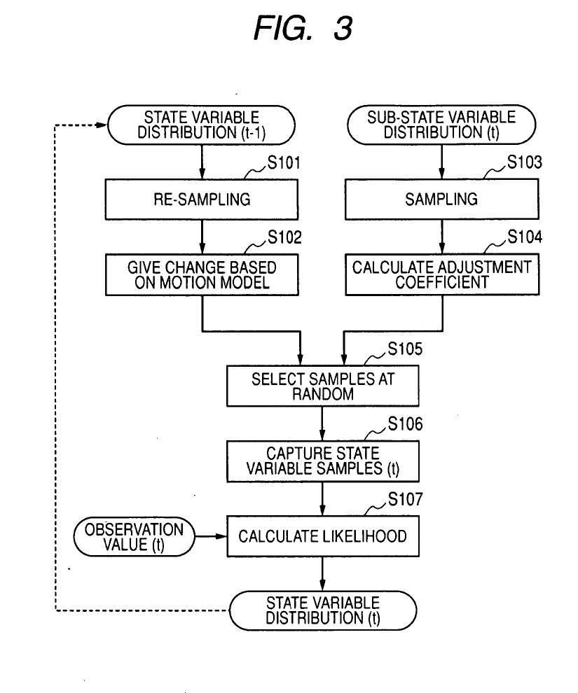

FIG. 3 is a flowchart of a flow of processing by the integrated-tracking processing unit 1. As explained above, the processing by the integrated-tracking processing unit 1 is established on the basis of ICondensation. For convenience of explanation, assuming that an observation value in the processing is based on an image, time (t, t−1) is replaced with a frame (t, t−1). In other words, a frame of an image is also included in a concept of time.

First, in step S101, the integrated-tracking processing unit 1 re-samples respective samples forming a sample set of a state variable distribution (t−1) (a sample set in a frame t−1) obtained as an estimation result by the integrated-tracking processing unit 1 at the immediately preceding frame t−1 (re-sampling).

The state variable distribution (t−1) is represented as follows.

P(Xₜ₋₁|Z_{1:t-1}) (Formula 1)
Xₜ₋₁ . . . state variable at frame t−1
Z_{1:t-1} . . . observation value in frames 1 to

When samples obtained in the frame “t” is represented by

Sₜ⁽ⁿ⁾ (Formula 2)

respective N weighted samples forming the sample set as the state variable distribution (t−1) are represented as follows.

{Sₜ₋₁⁽ⁿ⁾, πₜ₋₁⁽ⁿ⁾} (Formula 3)

In Formulas 2 and 3, π represents a weighting coefficient and a variable “n” represents an nth sample among the N samples forming the sample set.

In the next step S102, the integrated-tracking processing unit 1 generates a sample set of the frame “t” (state variable sample candidates at first present time) by moving, according to a prediction model of a motion (a motion model) calculated in association with a tracking target, the respective samples re-sampled in step S101 to new positions.

On the other hand, if a sub-state variable distribution (t) can be obtained from the sub-state-variable-distribution output unit 2 in the frame “t”, in step S103, the integrated-tracking processing unit 1 samples the sub-state variable distribution (t) to generate a sample set of the sub-state variable distribution (t).

As it is understood from the following explanation, the sample set of the sub-state variable distribution (t) generated in step S103 can be a sample set of state variable samples (t) (state variable sample candidates at second present time). However, since the sample set generated in step S103 has a bias, it is undesirable to directly use the sample set for integration. Therefore, for adjustment for offsetting this bias, in step S104, the integrated-tracking processing unit 1 calculates an adjustment coefficient λ.

As it is understood from the following explanation, the adjustment coefficient λ should be given to the weighting coefficient π and is calculated, for example, as follows.

$${λ}_{1}^{( n )} = \{ \begin{matrix}\frac{{f}_{t} ( {s}_{t}^{( n )} )}{{g}_{t} ( {s}_{t}^{( n )} )} = \frac{( {\sum }_{j = 1}^{N} {π}_{t - 1}^{( j )} p ( \begin{matrix}{X}_{t} = {s}_{t}^{( n )} \vert \\ {X}_{t - 1} = {s}_{t - 1}^{( j )}\end{matrix} ) )}{{g}_{t} ( {s}_{t}^{( n )} )} & {g}_{t} ( X ) {s}_{t}^{( n )} \\ 1 & \{ {s}_{t - 1}^{( n )} , {π}_{t - 1}^{( j )} \} {s}_{t}^{( n )}\end{matrix} \\ {g}_{t} ( X ) … supplementary state variable distribution ( t ) ( presence probability ) p ( {X}_{t} = {s}_{t}^{( n )} \vert {X}_{t - 1} = {s}_{t - 1}^{( j )} … transition probabillity of state variable including a motion model . \qquad ( Formula 4 )$$

An adjustment coefficient (shown in Formula 4) for the sample set obtained in steps S101 and S102 on the basis of the state variable distribution (t−1) is fixed at 1 and is not subjected to bias offset adjustment. On the other hand, the significant adjustment coefficient λ calculated in step S104 is allocated to the samples of the sample set obtained in step S103 on the basis of the sub-state variable distribution (t) (a presence distribution gt(X)).

In step S105, the integrated-tracking processing unit 1 selects at random, according to a ratio set in advance (a selection ratio), the samples in any one of the sample set obtained in steps S101 and S102 on the basis of the state variable distribution (t−1) and the sample set obtained in step S103 on the basis of the sub-state variable distribution (t) In step S106, the integrated-tracking processing unit 1 captures the selected samples as state variable samples (t). The respective samples forming the sample set as the state variable samples (t) are represented as follows.

{Sₜ⁽ⁿ⁾, λₜ^{(j)}} (Formula 5)

In step S107, the integrated-tracking processing unit 1 executes rendering processing for a tracking target such as a person posture using values of state variables of the respective samples forming the sample set (Formula 5) to which the adjustment coefficient is given. The integrated-tracking processing unit 1 performs matching of an image obtained by this rendering and an actual observation value (t) (an image) and calculates likelihood according to a result of the matching.

This likelihood is represented as follows.

p(Zₜ|Xₜ=sₜ^{(j)} (Formula 6)

In step S107, the integrated-tracking processing unit 1 multiplies the calculated likelihood (Formula 6) with the adjustment coefficient (Formula 4) calculated in step S104. A result of this calculation represents weight concerning the respective samples forming the state variable samples (t) in the frame “t” and is a prediction of the state variable distribution (t). The state variable distribution (t) can be represented as Formula 7. A distribution predicted in the frame “t” can be represented as Formula 8.

P(Xₜ|Z_{1:t}) (Formula 7)

P(Xₜ|Z_{1:t})˜{sₜ⁽ⁿ⁾, λₜ^{(j)} P(Zₜ|Xₜ=sₜ⁽ⁿ⁾)} (Formula 8)

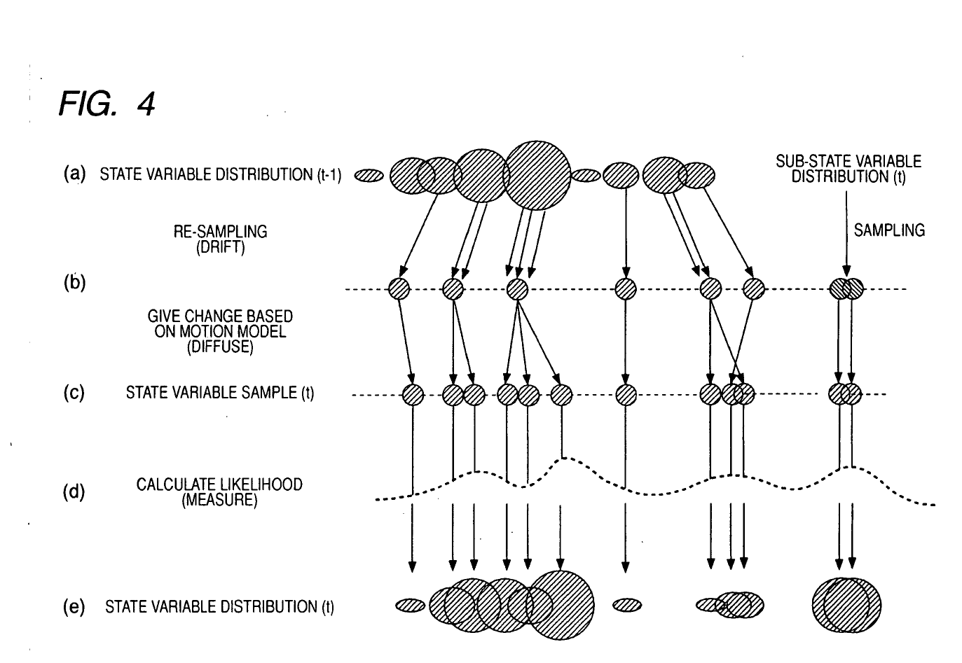

FIG. 4 is a schematic diagram of the flow of the processing shown in FIG. 3 mainly as state transition of samples.

In (a) of FIG. 4, a sample set including weighted samples forming the state variable distribution (t) is shown. This sample set is a target to be re-sampled in step S101 in FIG. 3. As it is seen from a correspondence indicated by arrows between spots in (a) of FIG. 4 and samples in (b) of FIG. 4, in step S101, for example, the integrated-tracking processing unit 1 re-samples, from the sample set shown in (a) of FIG. 4, samples in positions selected according to a degree of weighting.

In (b) of FIG. 4, a sample set obtained by the re-sampling is shown. Processing of the re-sampling is also called drift.

In parallel to the processing, as shown on the right side in (b) of FIG. 4, in step S103 in FIG. 3, the integrated-tracking processing unit 1 obtains a sample set generated by sampling the sub-state variable distribution (t). Although not shown in the figure, the integrated-tracking processing unit 1 also performs the calculation of the adjustment coefficient λ in step S104 according to the sampling of the sub-state variable distribution (t).

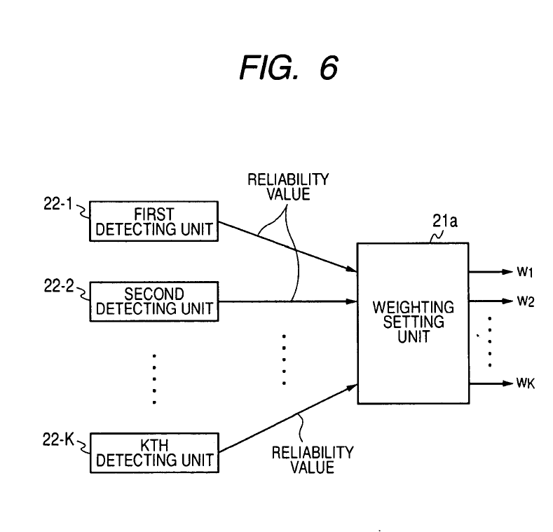

Transition of samples from (b) to (c) of FIG. 4 indicates movement (diffuse) of sample positions by the motion model in step S102 in FIG. 3. Therefore, a sample set shown in FIG. 4(c) is a candidate of the state variable samples (t) that should be captured in step S106 in FIG. 6.

The movement of the sample positions is performed, on the basis of the state variable distribution (t−1), only for the sample set obtained through the procedure of steps S101 and S102. The movement of the sample positions is not performed for the sample set obtained by sampling the sub-state variable distribution (t) in step S103. The sample set is directly treated as a candidate of the state variable samples (t) corresponding to (c) of FIG. 4. In step S105, the integrated-tracking processing unit 1 selects one of the sample set based on the state variable distribution (t−1) shown in (c) of FIG. 4 and the sample set based on the sub-state variable distribution (t) as a sample set that should be used for actual likelihood calculation and sets the sample set as normal state variable samples (t).

In (d) of FIG. 4, likelihood calculated by the likelihood calculation in step S107 in FIG. 3 is schematically shown. Prediction of the state variable distribution (t) shown in (e) of FIG. 4 is performed according to the likelihood calculated in this way.

Actually, it is likely that an error occurs in a tracking result or a posture estimation result and a large difference occurs between the sample set corresponding to the state variable distribution (t−1) and the sub-state variable distribution (t) (the presence distribution gt (X)). In this case, the adjustment coefficient λ is extremely small and the samples based on the presence distribution gt (X) are not valid.

In order to prevent such a situation, actually, in the flow of the procedure in steps S103 and S104 in FIG. 3, the integrated-tracking processing unit 1 selects several samples at random out of the samples forming the sample set based on the presence distribution gt(X) according to a predetermined ratio set in advance and, then, sets 1 as the adjustment coefficient λ for the selected samples according to predetermined rate and ratio set in advance.

The state variable distribution (t) obtained by the processing can be represented as follows.

\tilde{P}(Xₜ|Z_{1:t-1})=(1−rₜcₜ)P(Xₜ|Z_{1:t-1})+rₜcₜgₜ(X)

rₜ . . . rate of seleecting samples from gₜ(X)

cₜ . . . rate of setting λₜ^{(r)} to 1 (Formula 9)

According to Formula 9, it can be said that the state variable distribution (t) and the presence distribution gt(X) are a liner combination.

The integrated tracking based on ICondensation explained above has a high degree of freedom because other information (the sub-state variable distribution (t)) is probabilistically introduced (integrated). It is easy to adjust a necessary amount of introduction according to setting of a ratio to be introduced. Since the likelihood is calculated, if information as a prediction result is correct, the information is enhanced and, if the information is wrong, the information is suppressed. Consequently, high accuracy and robustness are obtained.

For example, in the method of ICondensation described in Non-Patent Document 1, the information introduced for integration as the sub-state variable distribution (t) is limited to a single detection target such as skin color detection.

However, as information hat can be introduced, besides the skin color detection, various kinds of information are conceivable. For example, it is conceivable to introduce information obtained by a tracking algorithm of some system. However, since tracking algorithms have different characteristics and advantages according to systems thereof, determination in narrowing down information, which should be introduced, to one is difficult.

Judging from the above, for example, in the integrated tracking based on ICondensation, if plural kinds of information are introduced, it can be expected that improvement of performance such as prediction accuracy and robustness is realized.

Therefore, according to this embodiment, it is proposed to make it possible to perform, for example, on the basis of ICondensation, integrated tracking by introducing plural kinds of information. This point is explained below.

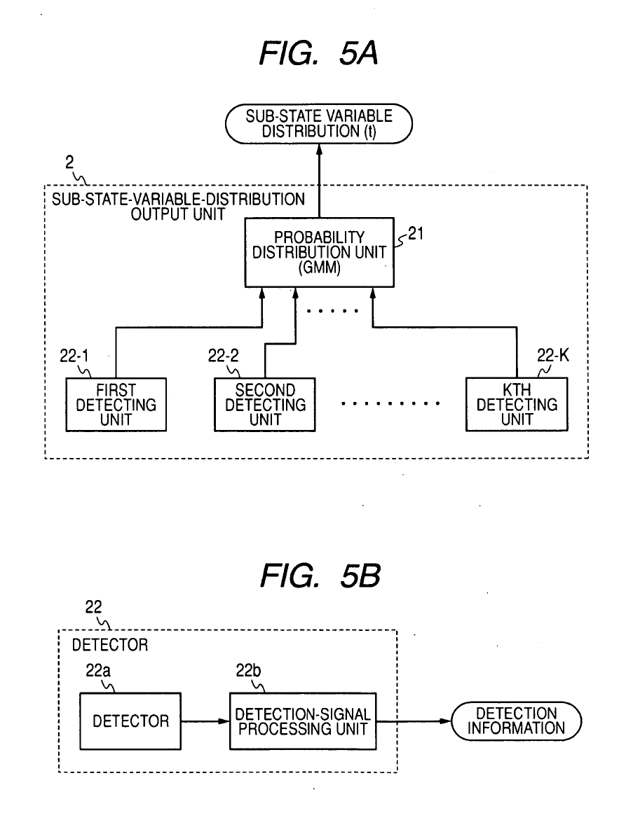

FIG. 5A is a diagram of a configuration of the sub-state-variable-distribution output unit 2, which is extracted from FIG. 1, as a configuration example of an integrated tracking system according to this embodiment that introduces plural kinds of information. A configuration of the entire integrated tracking system shown in FIG. 5A may be the same as that shown in FIG. 1. In other words, FIG. 5A can be regarded as illustrating an internal configuration of the sub-state-variable-distribution output unit 2 in FIG. 1 as a configuration according to this embodiment.

The sub-state-variable-distribution output unit 2 shown in FIG. 5A includes K first to Kth detecting units 22-1 to 22-K and a probability distribution unit 21.

Each of the first to Kth detecting units 22-1 to 22-K is a section that performs detection concerning a predetermined detection target related to a tracking target according to predetermined detection system and algorithm. Information concerning detection results obtained by the first to Kth detecting units 22-1 to 22-K is captured by the probability distribution unit 21.

FIG. 5B is a diagram of a generalized configuration example of a detecting unit 22 (the first to Kth detecting units 22-1 to 22-K).

The detecting unit 22 includes a detector 22a and a detection-signal processing unit 22b.

The detector 22a has, according to a detection target, a predetermined configuration for detecting the detection target. For example, in the skin color detection, the detector 22a is an imaging device or the like that performs imaging to obtain an image signal as a detection signal.

The detection-signal processing unit 22b is a section that is configured to perform necessary processing for a detection signal output from the detector 22a and finally generate and output detection information. For example, in the skin color detection, the detection-signal processing unit 22b captures an image signal obtained by the detector 22a as the imaging device, detects an image area portion recognized as a skin color on an image as this image signal, and outputs the image area portion as detection information.

The probability distribution unit 21 shown in FIG. 5A performs processing for converting detection information captured from the first to Kth detecting units 22-1 to 22-K into one sub-state variable distribution (t) (the presence distribution gt(X)) that should be introduced by the integrated tracking system 1.

As a method for the processing, several methods are conceivable. In this embodiment, the probability distribution unit 21 is configured to integrate the detection information captured from the first to Kth detecting units 22-1 to 22-K and converting the detection information into a probability distribution to generate the presence distribution gt(X). As a method of the probability distribution for obtaining the presence distribution gt(X), a method of expanding the detection information to a GMM (Gaussian Mixture Model) is adopted. For example, Gaussian distributions (normal distributions) are calculated for the respective kinds of detection information captured from the first to Kth detecting units 22-1 to 22-K and are mixed and combined.

The probability distribution unit 21 according to this embodiment is configured to, as explained below, appropriately give necessary weighting to the detection information captured from the first to Kth detecting units 22-1 to 22-K and then obtain the presence distribution gt(X).

As shown in FIG. 6, each of the first to Kth detecting units 22-1 to 22-K is configured to be capable of calculating reliability concerning a detection result for a detection target corresponding to the detecting unit and outputting the reliability as, for example, a reliability value.

As shown in FIG. 6, the probability distribution unit 21 according to this embodiment includes an execution section as the weighting setting unit 21a. The weighting setting unit 21a captures reliability values output from the first to Kth detecting units 22-1 to 22-K. The weighting setting unit 21a generates, on the basis of the captured reliability values, weighting coefficients w1 to wK corresponding to the respective kinds of detection information output from the first to Kth detecting units 22-1 to 22-K. As an actual algorithm for setting the weighting coefficients w, various algorithms are conceivable. Therefore, explanation of a specific example of the algorithm is omitted. However, a higher value is requested for the weighting coefficient according to an increase in the reliability value.

The probability distribution unit 21 can calculate the presence distribution gt(X) as a GMM as explained below using the weighting coefficients w1 to wK obtained as explained above. In Formula 10, μ1 is detection information of the detector 22-i (1≦i≦K).

$$\begin{matrix}g ( x ) = {\sum }_{i = 1}^{K} {w}_{i} N ( {μ}_{i} , {\sum }_{i} ) \\ = {\sum }_{i = 1}^{K} \frac{{w}_{i}}{{( 2 π )}^{d / 2} {\vert {\sum }_{i} \vert}^{1 / 2}} exp [ - \frac{1}{2} {( x - {μ}_{i} )}^{′} {\sum }_{i}^{- 1} ( x - {μ}_{i} ) ] \\ {\sum }_{i = 1}^{K} {w}_{i} = 1\end{matrix} \qquad ( Formula 10 )$$

In general, a diagonal matrix shown below is used as ρi in Formula 10.

Σᵢ=diag(σ₁², . . . , σ_{d}²) (Formula 11)

After weighting is give to each of the kinds of detection information output from the first to Kth detecting units 22-1 to 22-K, the presence distribution gt(X) (the sub-state variable distribution (t)) is generated. Therefore, prediction of the state variable distribution (t) is performed after increasing an introduction ratio of detection information for which high reliability is obtained. In this embodiment, this also realizes improvement of performance concerning tracking processing.

An example of correspondence between the elements of the present invention and the components according to this embodiment is explained below.

The integrated-tracking processing unit 1 that executes steps S101 and S102 in FIG. 3 corresponds to the first state-variable-sample-candidate generating means.

The first to Kth detecting units 22-1 to 22-K shown in FIG. 5A correspond to the plural detecting means.

The probability distribution unit 21 shown in FIG. 5A corresponds to the sub-information generating means.

The integrated-tracking processing unit 1 that executes steps S103 and S104 in FIG. 3 corresponds to the second state-variable-sample-candidate generating means.

The integrated-tracking processing unit 1 that executes steps S105 and S106 in FIG. 3 corresponds to the state-variable-sample acquiring means.

The integrated-tracking processing unit 1 that executes the processing explained as step S107 in FIG. 3 corresponds to the estimation-result generating means.

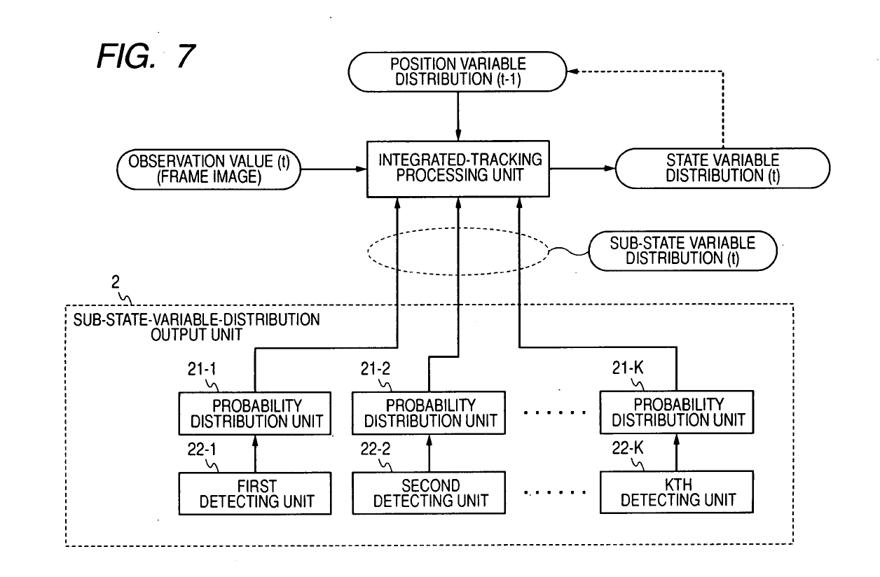

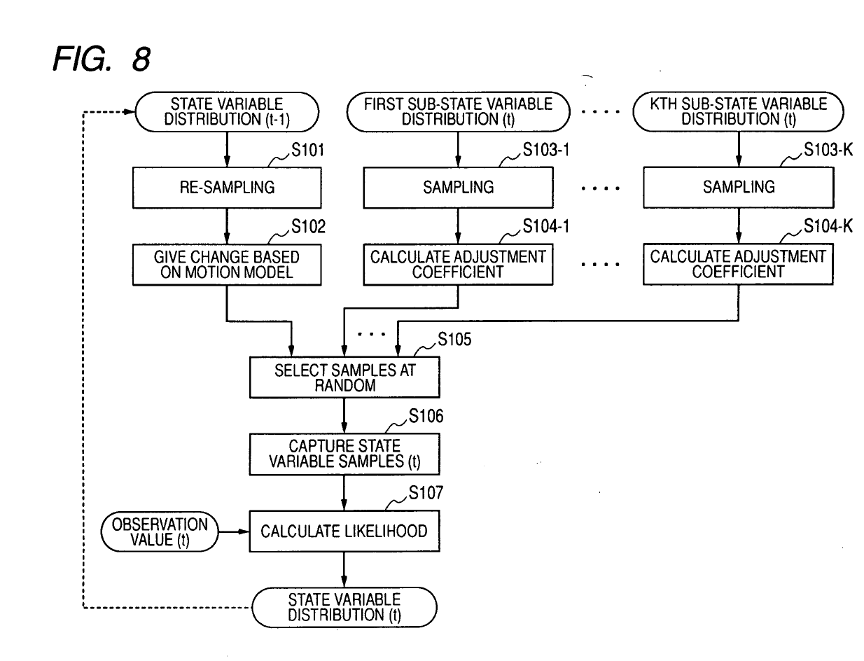

Another configuration example of the integrated-tracking system for introducing plural kinds of information and performing integrated tracking according to this embodiment is explained below with reference to FIGS. 7 and 8.

As shown in FIG. 7, in the integrated tracking system in this case, the sub-state-variable-distribution output unit 2 includes K probability distribution units 21-1 to 21-K in association with the first to Kth detecting units 22-1 to 22-K.

The probability distribution unit 21-1 corresponding to the first detecting unit 22-1 performs processing for capturing detection information output from the first detecting unit 22-1 and converting the detection information into a probability distribution. Concerning the processing of the probability distribution, various algorithms and systems therefor are conceivable. However, for example, if the configuration of the probability distribution unit 21 shown in FIG. 5A is applied, it is conceivable to obtain the probability distribution as a single Gaussian distribution (normal distribution).

Similarly, the remaining probability distribution units 21-2 to 21-K respectively perform processing for obtaining probability distributions from detection information obtained by the second to Kth detecting units 22-2 to 22-K.

In this case, the respective probability distributions output from the probability distribution units 21-1 to 21-K as explained above are input in parallel to the integrated-tracking processing unit 1 as a first sub-state variable distribution (t) to a Kth sub-state variable distribution (t).

Processing in the integrated-tracking processing unit 1 shown in FIG. 7 is shown in FIG. 8. In FIG. 8, procedures and steps same as those in FIG. 3 are denoted by the same step numbers.

As the processing of the integrated-tracking processing unit 1 shown in the figure, first, steps S101 and S102 executed on the basis of the state variable distribution (t−1) are the same as those in FIG. 3.

Then, as indicated by steps S103-1 to S103-K and steps S104-1 to S104-K in the figure, the integrated-tracking processing unit 1 in this case performs sampling for each of the first sub-state variable distribution (t) to the Kth sub-state variable distribution (t) to generate a sample set that can be the state variable samples (t) and calculates the adjustment coefficient λ.

In steps S105 and S106 in this case, the integrated-tracking processing unit 1 selects at random, for example, according to a ratio set in advance, any one set of 1+K sample sets including a sample set based on the state variable distribution (t−1) and sample sets based on the first to Kth sub-state variable distributions (t) and captures the state variable samples (t). Thereafter, in the same manner as the flow shown in FIG. 3, the integrated-tracking processing unit 1 calculates likelihood in step S107 and obtains the state variable distribution (t) as a prediction result.

In this configuration example, it is conceivable to pass reliability values obtained in the first to Kth detecting units 22-1 to 22-K to, for example, the integrated-tracking processing unit 1.

The integrated-tracking processing unit 1 changes and sets, on the basis of the received reliability values, a selection ratio among the first to Kth sub-state variable distributions (t) as a selection ratio in the selection in step S105 in FIG. 8.

Alternatively, it is also conceivable that, in step S107 in FIG. 8, the integrated-tracking processing unit 1 multiplies the likelihood with the adjustment coefficient λ and the weighting coefficient (w) set according to the reliability values.

With such a configuration, as in the case of the configuration example shown in FIGS. 5A and 5B, the integrated tracking processing is performed by giving weight to detection information having high reliability among the detection information of the detecting units 22-1 to 22-K.

Alternatively, the first to Kth detecting units 22-1 to 22-K pass the respective reliability values to the probability distribution units 21-1 to 21-K corresponding thereto. It is also conceivable that the probability distribution units 21-1 to 21-K change, according to the received reliability values, density, intensity, and the like of distributions to be generated.

In this configuration example, the respective plural kinds of detection information obtained by the plural first to Kth detecting units 22-1 to 22-K are converted into probability distributions, whereby the plural sub-state variable distributions (t) corresponding to the respective kinds of detection information are generated and passed to the integrated-tracking processing unit 1. On the other hand, in the configuration example shown in FIGS. 5A and 5B, the kinds of detection information obtained by the first to Kth detecting units 22-1 to 22-K are mixed and converted into distributions to be integrated into one, whereby one sub-state variable distribution (t) is generated and passed to the integrated-tracking processing unit 1.

As explained above, regardless of whether one sub-state variable distribution (t) or the plural sub-state variable distributions (t) are generated, the configuration example shown in FIGS. 5A and 5B and this configuration example are the same in that the sub-state variable distribution(s) (t) (the sub-state variable probability distribution information at the present time) is generated on the basis of the plural kinds of detection information obtained by the plural detecting units.

In this configuration example, the processing explained above is executed, whereby a result of introducing the plural first to Kth sub-state variables (t) to the state variable distribution (t−1) is obtained in unit time. For example, improvement of reliability same as that in the configuration explained with reference to FIGS. 5A and 5B and FIG. 6 is realized.

Specific application examples of the integrated tracking system according to this embodiment explained above are explained below.

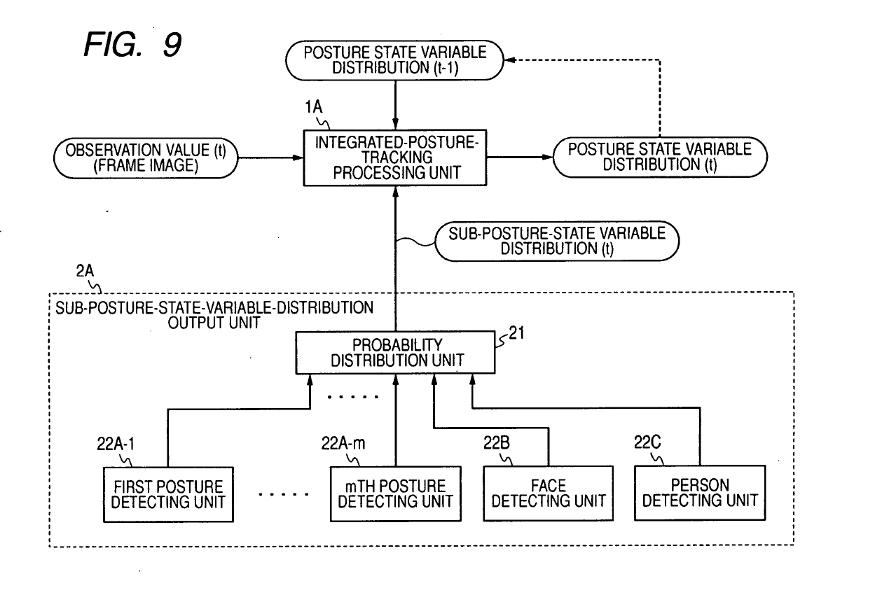

FIG. 9 is a diagram of an example of the integrated tracking system according to this embodiment applied to tracking of a posture of a person. Therefore, the integrated-tracking processing unit 1 is shown as an integrated-posture-tracking processing unit 1A. The sub-state-variable-distribution output unit 2 is shown as a sub-posture-state-variable-distribution output unit 2A.

In the figure, an internal configuration of the sub-posture-state-variable-distribution output unit 2A is similar to the internal configuration of the sub-state-variable-distribution output unit 2 shown in FIGS. 5A and 5B and FIG. 6. It goes without saying that the internal configuration of the sub-posture-state-variable-distribution output unit 2A can be configured to be similar to that shown in FIGS. 7 and 8. The same holds true for the other application examples explained below.

In this case, a posture of a person is set as a tracking target. Therefore, for example, joint positions and the like are set as state variables in the integrated-posture-tracking processing unit 1A. A motion model is also set according to the posture of the person.

The integrated-posture-tracking processing unit 1A captures a frame image in the frame “t” as the observation value (t). The frame image as the observation value (t) can be obtained through, for example, imaging by an imaging device. The posture state variable distribution (t−1) and the sub-posture state variable distribution (t) are captured together with the frame image as the observation value (t). The posture state variable distribution (t) is generated and output by the configuration according to this embodiment explained with reference to FIGS. 5A and 5B and FIG. 6. In other words, an estimation result concerning the person posture is obtained.

The sub-posture-state-variable-distribution output unit 2A in this case includes, as the detecting units 22, m first to mth posture detecting units 22A-1 to 22A-m, a face detecting unit 22B, and a person detecting unit 22C.

Each of the first to mth posture detecting units 22A-1 to 22A-m has a detector 22a and a detection-signal processing unit 22b corresponding to predetermined system and algorithm for person posture estimation, estimates a person posture, and outputs a result of the estimation as detection information.

Since the plural posture detecting units are provided in this way, in estimating a person posture, it is possible to introduce plural estimation results by different systems and algorithms. Consequently, it is possible to expect that higher reliability is obtained compared with introduction of only a single posture estimation result.

The face detecting unit 22B detects an image area portion recognized as a face from the frame image and sets the image area portion as detection information. In correspondence with FIG. 5B, the face detecting unit 22B in this case only has to be configured to obtain a frame image through imaging by the detector 22a as the imaging device and execute image signal processing for detecting a face from the frame image with the detection-signal processing unit 22b.

By using a result of the face detection, it is possible to highly accurately estimate the center of a head of a person as a target of posture estimation. If information obtained by estimating the center of the head is used, it is possible to hierarchically estimate, for example, as a motion model, positions of joints starting from the head.

The person detecting unit 22C detects an image area portion recognized as a person from the frame image and sets the image area portion as detection information. In correspondence with FIG. 5B, the person detecting unit 22C in this case also only has to be configured to obtain a frame image through imaging by the detector 22a as the imaging device and execute image signal processing for detecting a person from the frame image with the detection-signal processing unit 22b.

By using a result of the person detection, it is possible to highly accurately estimate the center (the center of gravity) of a body of a person as a target of posture estimation. If information obtained by estimating the center of the body is used, it is possible to more accurately estimate a position of the person as the estimation target.

As explained above, the face detection and the person detection is not detection for detecting a posture of the person per se. However, as it is understood from the above, like the detection information of the posture detecting unit 22A, the detection information can be treated as information substantially related to posture estimation of the person.

A method of posture detection that can be applied to the first to mth posture detecting units 22A-1 to 22A-m should not be limited. However, in this embodiment, according to results of experiments and the like of the inventor, there are two methods regarded as particularly effective.

One is a three-dimensional body tracking method applied for patent by the applicant earlier (Japanese Patent Application 2007-200477). The other is a method of posture estimation described in “Ryuzo Okada and Bjorn Stenger, “Human Posture Estimation using Silhouette-Tree-Based Filtering”, In Proc. of the image recognition and understanding symposium, 2006”.

The inventor performed experiments by applying several methods concerning the detecting units 22 configuring the sub-posture-state-variable-distribution output unit 2A of the integrated-posture tracking system shown in FIG. 9. As a result, it was confirmed that reliability higher than that obtained, for example, when single information was introduced to perform integrated posture tracking. In particular, it was confirmed that the two methods were effective for posture estimation processing corresponding to the posture detecting unit 22A. In particular, it was confirmed that, when the three-dimensional body tracking method was introduced (in the posture detecting units 22A-1 and 22A-2), face detection processing corresponding to the face detecting unit 22B, and person detecting processing corresponding to the person detecting unit 22C were also effective and, among these kinds of processing, human detection was particularly effective. In practice, it was confirmed that particularly high reliability was obtained in an integrated processing system configured by adopting at least the three-dimensional body tracking and the person detection processing.

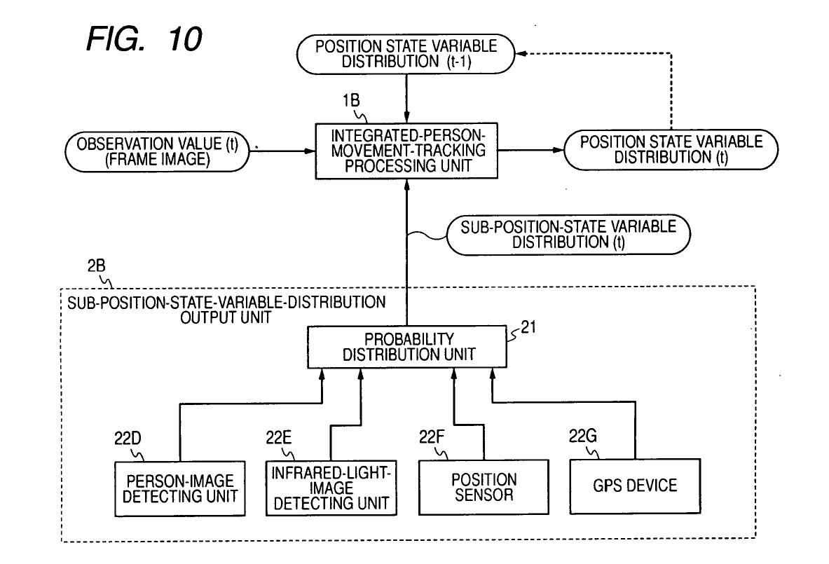

FIG. 10 is a diagram of an example of the integrated tracking system according to this embodiment applied to tracking of movement of a person. Therefore, the integrated-tracking processing unit 1 is shown as an integrated-person-movement-tracking processing unit 1B. The sub-state-variable-distribution output unit 2 is shown as a sub-position-state-variable-distribution output unit 2B because the unit outputs a state variable distribution corresponding to a position of a person as a tracking target.

The integrated-person-movement-tracking processing unit 1B sets proper parameters such as a state variable and a motion model to set the tracking target as a moving locus of the person.

The integrated-person-movement-tracking processing unit 1B captures a frame image in the frame “t” as the observation value (t). The frame image as the observation value (t) can also be obtained through, for example, imaging by an imaging device. The integrated-person-movement-tracking processing unit 1B captures, together with the frame image as the observation value (t), the position state variable distribution (t−1) and the sub-position state variable distribution (t) corresponding to the position of the person as the tracking target and generates and outputs the position state variable distribution (t) using the configuration according to this embodiment explained with reference to FIGS. 5A and 5B and FIG. 6. In other words, the integrated-person-movement-tracking processing unit 1B obtains an estimation result concerning a position where the person as the tracking target is considered to be present according to the movement.

The sub-position-state-variable-distribution output unit 2B in this case includes, as the detecting units 22, a person-image detecting unit 22D, an infrared-light-image-use detecting unit 22E, a sensor 22F, and a GPS device 22G. The sub-position-state-variable-distribution output unit 2B is configured to capture detection information of these detecting units using the probability distribution unit 21.

The person-image detecting unit 22D detects an image area portion recognized as a person from the frame image and sets the image area portion as detection information. Like the person detecting unit 22C, in correspondence with FIG. 5B, the person-image detecting unit 22D only has to be configured to obtain a frame image through imaging by the detector 22a as the imaging device and execute image signal processing for detecting a person from the frame image using the detection-signal processing unit 22b.

By using a result of the person detection, it is possible to track the center (the center of gravity) of a body of a person who is set as a tracking target and moves in an image.

The infrared-light-image-use detecting unit 22E detects an image area portion as a person from, for example, an infrared light image obtained by imaging infrared light and sets the image area portion as detection information. A configuration corresponding to that shown in FIG. 5B for the infrared-light-image-use detecting unit 22E only has to be considered to have the detector 22a as an imaging device that images, for example, infrared light (or near infrared light) and obtains an infrared light image and the detection-signal processing unit 22b that executes person detection through image signal processing for the infrared light image.

According to a result of the person detection by the infrared-light-image-use detecting unit 22E, it is also possible to track the center (the center of gravity) of a body of a person who is set as a tracking target and moves in an image. In particular, since the infrared light image is used, reliability of detection information is high when imaging is performed in an environment with a small light amount.

The sensor 22F is attached to, for example, the person as the tracking target and includes, for example, a gyro sensor or an angular velocity sensor. A detection signal of the sensor 22F is input to the probability distribution unit 21 in the sub-position-state-variable-distribution output unit 2B by, for example, radio.

The detecting unit 22a as the sensor 22F is a detection element of the gyro sensor or the angular velocity sensor. The detection-signal processing unit 22b calculates moving speed, moving direction, and the like from a detection signal of the detection element. The detection-signal processing unit 22b outputs information concerning the moving speed and the moving direction calculated in this way to the probability distribution unit 21 as detection information.

The GPS (Global Positioning System) device 22G is also attached to, for example, a person as a tracking target and configured to transmit position information acquired by a GPS by radio in practice. The transmitted position information is input to the probability distribution unit 21 as detection information. The detector 22a in this case is, for example, a GPS antenna. The detection-signal processing unit 22b is a section that is adapted to execute processing for calculating position information from a signal received by a GPS antenna.

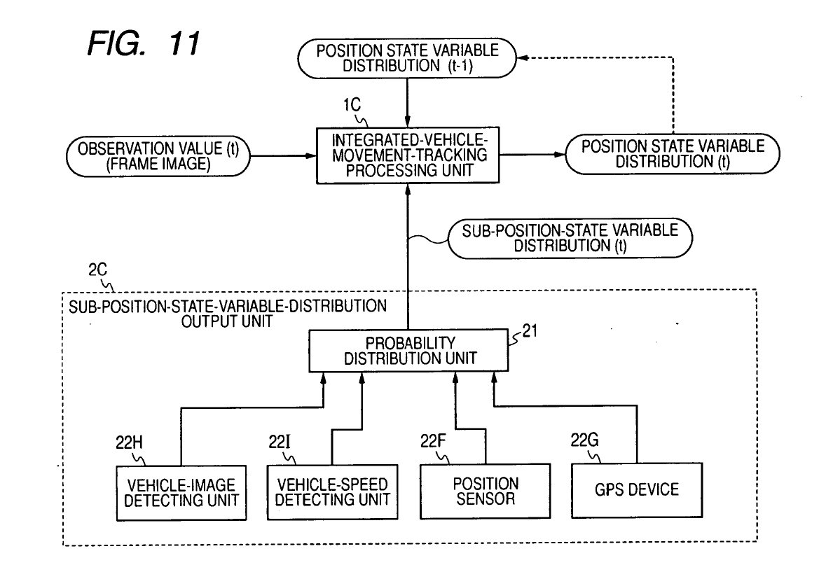

FIG. 11 is a diagram of an example of the integrated tracking system according to this embodiment applied to tracking of movement of a vehicle. Therefore, the integrated-tracking processing unit 1 is shown as an integrated-vehicle-tracking processing unit 1C. The sub-state-variable-distribution output unit 2 is shown as a sub-position-state-variable-distribution output unit 2C because the unit outputs a state variable distribution corresponding to a position of a vehicle as a tracking target.

The integrated-vehicle-tracking processing unit 1C in this case sets proper parameters such as a state variable and a motion model to set the vehicle as the tracking target.

The integrated-vehicle-tracking processing unit 1C captures a frame image in the frame “t” as the observation value (t), captures the position state variable distribution (t−1) and the sub-position state variable distribution (t) corresponding to the position of the vehicle as the tracking target, and generates and outputs the position state variable distribution (t). In other words, the integrated-vehicle-tracking processing unit 1C obtains an estimation result concerning a position where the vehicle as the tracking target is considered to be present according to the movement.

The sub-position-state-variable-distribution output unit 2C includes, as the detecting units 22, a vehicle-image detecting unit 22H, a vehicle-speed detecting unit 22I, the sensor 22F, and the GPS device 22G. The sub-position-state-variable-distribution output unit 2C is configured to capture detection information of these detecting units using the probability distribution unit 21.

The vehicle-image detecting unit 22H is configured to detect an image area portion recognized as a vehicle from a frame image and set the image area portion as detection information. In correspondence with FIG. 5B, the vehicle-image detecting unit 22H in this case is configured to obtain a frame image through imaging by the detector 22a as the imaging device and execute image signal processing for detecting a vehicle from the frame image using the detection-signal processing unit 22b.

By using a result of this vehicle detection, it is possible to recognize a position of a vehicle that is set as a tracking target and moves in an image.

The vehicle-speed detecting unit 22I performs speed detection concerning the vehicle as the tracking target using, for example, a radar and outputs detection information. In correspondence with FIG. 5B, the detector 22a is a radar antenna and the detection-signal processing unit 22b is a section for calculating speed from a radio wave received by the radar antenna.

The sensor 22F is, for example, the same as that shown in FIG. 10. When the sensor 22F is attached to the vehicle as the tracking target, the sensor 22F can obtain moving speed and moving direction of the vehicle as detection information.

Similarly, when the GPS 22G is attached to the vehicle as the tracking target, the GPS 22G can obtain position information of the vehicle as detection information.

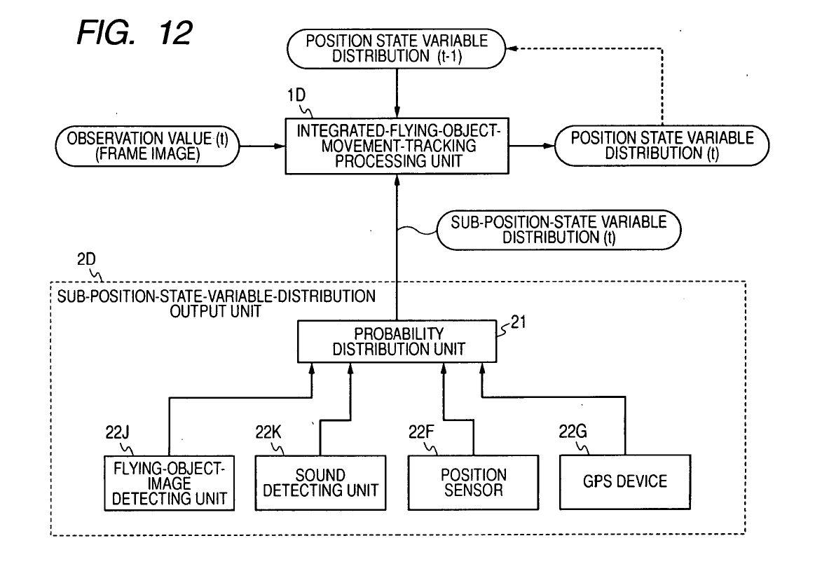

FIG. 12 is an example of the integrated tracking system according to this embodiment applied to tracking of movement of a flying object such as an airplane. Therefore, the integrated-tracking processing unit 1 is shown as an integrated-flying-object-tracking processing unit 1D. The sub-state-variable-distribution output unit 2 is shown as a sub-position-state-variable-distribution output unit 2D because the unit outputs a state variable distribution corresponding to a position of a flying object as a tracking target.

The integrated-flying-object-tracking processing unit 1D in this case sets proper parameters such as a state variable and a motion model to set a flying object as a tracking target.

The integrated-flying-object-tracking processing unit 1D captures a frame image in the frame “t” as the observation value (t), captures the position state variable distribution (t−1) and the sub-position state variable distribution (t) corresponding to the position of the flying object as the tracking target, and generates and outputs the position state variable distribution (t). In other words, the integrated-flying-object-tracking processing unit 1D obtains an estimation result concerning a position where the flying object as the tracking target is considered to be present according to the movement.

The sub-position-state-variable-distribution output unit 2C in this case includes, as the detecting units 22, a flying-object-image detecting unit 22J, a sound detecting unit 22K, the sensor 22F, and the GPS device 22G. The sub-position-state-variable-distribution output unit 2C is configured to capture detection information of these detecting units using the probability distribution unit 21.

The flying-object-image detecting unit 22J is configured to detect an image area portion recognized as a flying object from a frame image and set the image area portion as detection information. In correspondence with FIG. 5B, the flying-object-image detecting unit 22J in this case is configured to obtain a frame image through imaging by the detector 22a as the imaging device and execute image signal processing for detecting a flying object from the frame image using the detection-signal processing unit 22b.

By using a result of this flying object detection, it is possible to recognize a position of a flying object that is set as a tracking target and moves in an image.

The sound detecting unit 22K includes, for example, plural microphones as the detector 22a. The sound detecting unit 22K records sound of a flying object with these microphones and outputs the recorded sound as a detection signal. The detection-signal processing unit 22b calculates localization of the sound of the flying object from the recorded sound and outputs information indicating the localization of the sound as detection information.

The sensor 22F is, for example, the same as that shown in FIG. 10. When the sensor 22F is attached to the flying object as the tracking target, the sensor 22F can obtain moving speed and moving direction of the flying object as detection information.

Similarly, when the GPS 22G is attached to the flying object as the tracking target, the GPS 22G can also obtain the position information as detection information.

The method of three-dimensional body tracking that can be adopted as one of methods for the posture detecting unit 22A in the configuration for person posture integrated tracking shown in FIG. 9 is explained below. The method of three-dimensional body tracking is applied for patent by the applicant as Japanese Patent Application 2007-200477.

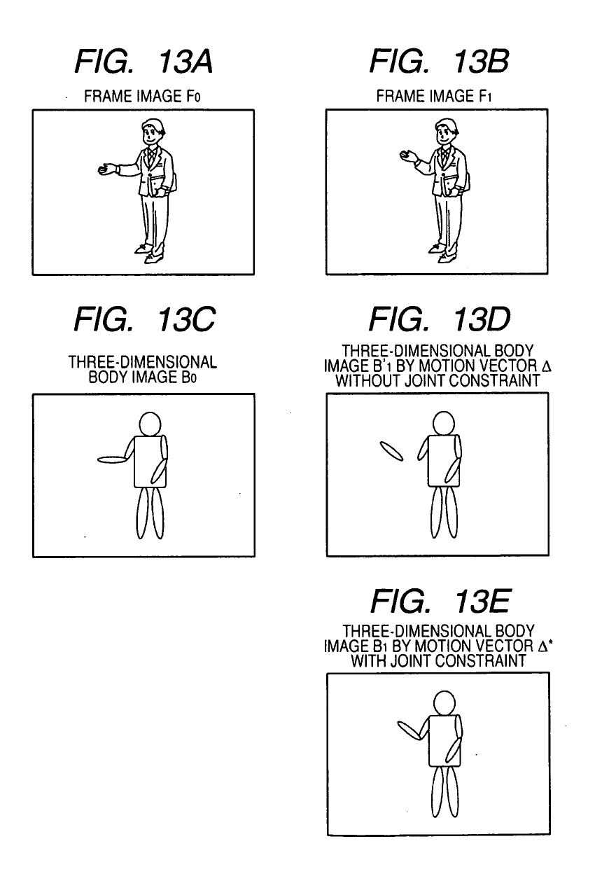

In the three-dimensional body tracking, for example, as shown in FIGS. 13A to 13E, a subject in a frame image F0 set as a reference of the frame images F0 and F1 photographed temporally continuously is divided into, for example, the head, the trunk, the portions from the shoulders to the elbows of the arms, the portions from the elbows of the arms to the finger tips, the portions from the waist to the knees of the legs, the portions from the knees to the toes, and the like. A three-dimensional body image B0 including the respective portions as three-dimensional parts is generated. Motions of the respective parts of the three-dimensional body image B0 are tracked on the basis of the frame image F1, whereby a three-dimensional body image B1 corresponding to the frame image F1 is generated.

When the motions of the respective parts are tracked, if the motions of the respective parts are independently tracked, the parts that should originally be connected by joints are likely to be separated (a three-dimensional body image B′1 shown in FIG. 13D). In order to prevent occurrence of such a deficiency, the tracking needs to be performed according to a condition that “the respective parts are connected to the other parts at predetermined joint points” (hereinafter referred to as joint constraint).

Many tracking methods adopting such joint constraint are proposed. For example, a method of projecting motions of respective parts independently calculated by an ICP (Iterative Closest Point) register method onto motions that satisfy joint constraint in a linear motion space is proposed in the following document (hereinafter referred to as “reference document”): “D. Demirdjian, T. Ko and T. Darrell, “Constraining Human Body Tracking”, Proceedings of ICCV, vol. 2, pp. 1071, 2003”.

The direction of the projection is determined by a correlation matrix Σ1 of ICP.

An advantage of determining the projecting direction using the correlation matrix Σ−1 of ICP is that a posture after moving respective parts of a three-dimensional body with the projected motions is closest to an actual posture of a subject.

Conversely, as a disadvantage of determining the projecting direction using the correlation matrix Σ−1 of ICP is that, since three-dimensional restoration is performed on the basis of parallax of two images simultaneously photographed by two cameras in the ICP register method, it is difficult to apply the ICP register method to a method of using images photographed by one camera. There is also a problem in that, since accuracy and an error of the three-dimensional restoration substantially depend on accuracy of determination of a projecting direction, the determination of a projecting direction is unstable. Further, the ICP register method has a problem in that a computational amount is large and processing takes time.

The invention applied for patent by the applicant earlier (Japanese Patent Application 2007-200477) is devised in view of such a situation and attempts to more stably perform the three-dimensional body tracking with a smaller computational amount and higher accuracy compared with the ICP register method. In the following explanation, the three-dimensional body tracking according to the invention applied for patent by the applicant earlier (Japanese Patent Application 2007-200477) is referred to as three-dimensional body tracking corresponding to this embodiment because the three-dimensional body tracking is adopted as the posture detecting unit 22A in the integrated posture tracking system shown as the embodiment in FIG. 9.

As the three-dimensional body tracking corresponding to this embodiment, a method of calculating, on the basis of a motion vector Δ without the joint constraint calculated by independently tracking the respective parts, a motion vector A* with the joint constraint in which the motions of the respective parts are integrated. Three-dimensional body tracking corresponding to this embodiment makes it possible to generate the three-dimensional body image B1 of a present frame by applying the motion vector Δ* to the three-dimensional body image B0 of the immediately preceding frame. This realizes the three-dimensional body tracking shown in FIGS. 13A to 13E.

In the three-dimensional body tracking corresponding to this embodiment, motions (changes in positions and postures) of the respective parts of the three-dimensional body are represented by two kinds of representation methods. An optimum target function is derived by using the respective representation methods.

First, a first representation method is explained. When motions of rigid bodies (corresponding to the respective parts) in a three-dimensional space are represented, linear transformation by a 4×4 transformation matrix in the past is used. In the first representation method, all rigid body motions are represented by a combination of a rotational motion with respect to a predetermined axis and a translational motion parallel to the axis. This combination of the rotational motion and the translational motion is referred to a spiral motion.

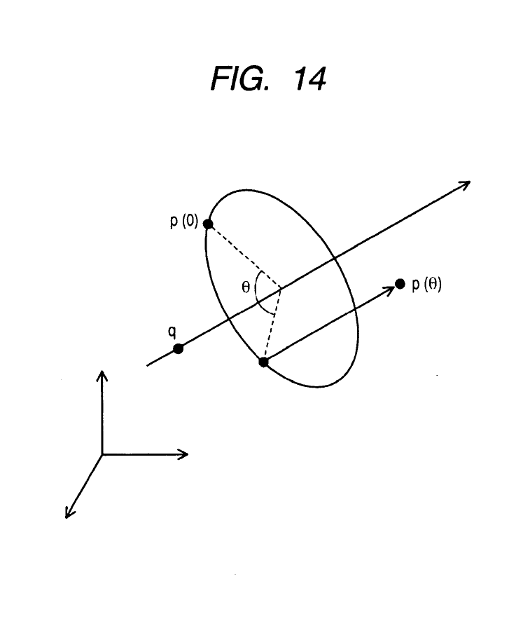

For example, as shown in FIG. 14, when a rigid body moves from a point p(0) to a point p(E) at a rotation angle θ of the spiral motion, this motion is represented by using an exponent as indicated by the following Equation (1).

p̅(θ)=e^{\dot{ξ}θ} p̅(0) (1)

eζθ(̂ above ζ is omitted in this specification for convenience of representation. The same applies in the following explanation) of Equation (1) indicates a motion (transformation) G and is represented by the following Equation (2) according to Taylor expansion.

$$G = {e}^{\hat{ξ} θ} = I + \hat{ξ} θ + \frac{{( \hat{ξ} θ )}^{2}}{2 !} + \frac{{( \hat{ξ} θ )}^{3}}{3 !} + … \qquad ( 2 )$$

In Equation (2), I indicates a unit matrix. ζ in the exponent portion indicates the spiral motion and represented by a 4×4 matrix or a six-dimensional vector in the following Equation (3).

$$\begin{matrix}\hat{ξ} = [ \begin{matrix}0 & - {ξ}_{3} & {ξ}_{2} & {ξ}_{4} \\ {ξ}_{3} & 0 & - {ξ}_{1} & {ξ}_{5} \\ - {ξ}_{2} & {ξ}_{1} & 0 & {ξ}_{6} \\ 0 & 0 & 0 & 0\end{matrix} ] \\ ξ = {[ {ξ}_{1} , {ξ}_{2} , {ξ}_{3} , {ξ}_{4} , {ξ}_{5} , {ξ}_{6} ]}^{t} \\ where & ( 3 ) \\ {ξ}_{1}^{2} + {ξ}_{2}^{2} + {ξ}_{3}^{2} = 1 & ( 4 )\end{matrix}$$

Accordingly, ζθ is as indicated by the following Equation

$$\hat{ξ} θ = [ \begin{matrix}0 & - {ξ}_{3} θ & {ξ}_{2} θ & {ξ}_{4} θ \\ {ξ}_{3} θ & 0 & - {ξ}_{1} θ & {ξ}_{5} θ \\ - {ξ}_{2} θ & {ξ}_{1} θ & 0 & {ξ}_{6} θ \\ 0 & 0 & 0 & 0\end{matrix} ] \\ ξθ = {[ {ξ}_{1} θ , {ξ}_{2} θ , {ξ}_{3} θ , {ξ}_{4} θ , {ξ}_{5} θ , {ξ}_{6} θ ]}^{t} \qquad ( 5 )$$

Among six independent variables ζ1θ, ζ2θ, α3θ, ζ4θ, ζ5θ, and α6θ of ζθ, ζ1θ to ζ3θ in the former half relate to the rotational motion of the spiral motion and ζ4θ to ζ6θ in the latter half relate to the translational motion of the spiral motion.

If it is assumed that “a movement amount of the rigid body between the continuous frame images F0 and F1 is small”, third and subsequent terms of Equation (2) can be omitted. The motion (transformation) G of the rigid body can be linearized as indicated by the following Equation (6).

(Formula 17)

G≈I+\hat{ξ}θ, (6)

When a movement amount of the rigid body between the continuous frame images F0 and F1 is large, it is possible to reduce the movement amount between the frames by increasing a frame rate during photographing. Therefore, it is possible to typically meet an assumption that “a movement amount of the rigid body between the continuous frame images F0 and F1 is small”, in the following explanation, Equation (6) is adopted as the motion (transformation) G of the rigid body.

A motion of a three-dimensional body including N parts (rigid bodies) is examined below. As explained above, motions of the respective parts are represented by vectors of ζθ. Therefore, a motion vector Δ of a three-dimensional body without joint constraint is represented by N vectors of ζθ as indicated by Equation (7).

Δ=[[ξθ]₁^{t}, . . . , [ξθ]_{N}ₜ]^{t} (7)

Each of the N vectors of ζθ has six independent variables ζ1θ to ζ6θ. Therefore, the motion vector Δ of the three-dimensional body is 6N-dimensional.

To simplify Equation (7), as indicated by the following Equation (8), among the six independent variables ζ1θ to ζ6θ, ζ1θ to ζ3θ in the former half related to the rotational motion of the spiral motion are represented by a three-dimensional vector ri and ζ4θ to ζ6θ in the latter half related to the translational motion of the spiral motion are represented by a three-dimensional vector ti.

$${r}_{i} = {[ \begin{matrix}{ξ}_{1} θ \\ {ξ}_{2} θ \\ {ξ}_{3} θ\end{matrix} ]}_{i} \\ {t}_{i} = {[ \begin{matrix}{ξ}_{4} θ \\ {ξ}_{5} θ \\ {ξ}_{6} θ\end{matrix} ]}_{i} \qquad ( 8 )$$

As a result, Equation (7) can be simplified as indicated by the following Equation (9).

Δ=[[r₁]^{t}, [t₁]^{t}, . . . , [r_{N}]^{t}, [t_{N}]^{t}]^{t} (9)

Actually, it is necessary to apply the joint constraint to the N parts forming the three-dimensional body. Therefore, a method of calculating a motion vector Δ* of the three-dimensional body with the joint constraint from the motion vector Δ of the three-dimensional body without the joint constrain is explained below.

The following explanation is based on an idea that a difference between a posture of the three-dimensional body after transformation by the motion vector Δ and a posture of the three-dimensional body after transformation by the motion vector Δ* is minimized.

Specifically, arbitrary three points (the three points are not present on the same straight line) of the respective parts forming the three-dimensional body are determined. The motion vector Δ* that minimizes distances between the three points of the posture of the three-dimensional body after transformation by the motion vector Δ and the three points of the posture of the three-dimensional body after transformation by the motion vector Δ* is calculated.

When the number of joints of the three-dimensional body is assumed to be M, as described in the reference document, the motion vector Δ* of the three-dimensional body with the joint constraint belongs to a null space {φ} of a 3M×6N joint constraint matrix φ established by joint coordinates.

The joint constraint matrix φ is explained below. M joints are indicated by Ji (i=1, 2, . . . , M) and indexes of parts where joints Ji are coupled are indicated by mi and ni. A 3×6N submatrix indicated by the following Equation (10) is generated with respect to the respective joints Ji.

$${submatrix}_{i} ( φ ) = ( {0}_{3} … {{( {J}_{1} )}_{X}}^{{m}_{i}} {- {I}_{3}}^{{m}_{i} + 1} … - {{( {J}_{1} )}_{X}}^{{n}_{i}} { {I}_{3} …}^{{n}_{i} + 1 } {0}_{3} ) \qquad ( 10 )$$

In Equation (10), 03 is a 3×3 null matrix and I3 is a 3×3 unit matrix.

A 3M×6N matrix indicated by the following Equation (11) is generated by arranging M 3×6N submatrixes obtained in this way along a column. This matrix is the joint constraint matrix φ.

$$φ = [ \begin{matrix}{submatrix}_{1} ( φ ) \\ {submatrix}_{2} ( φ ) \\ ⋮ \\ {submatrix}_{M} ( φ )\end{matrix} ] \qquad ( 11 )$$

If arbitrary three points not present on the same straight line in parts i (i=1, 2, . . . , N) among the N parts forming the three-dimensional body are represented as {pi1, pi2, pi3}, a target function is represented by the following Equation (12).

$$\{ \begin{matrix}{argmin}_{{Δ}^{*}} {\sum }_{i = 1}^{N} {\sum }_{j = 1}^{3} {‖ {p}_{ij} + {r}_{i} \times {p}_{ij} + {t}_{i} - ( {p}_{ij} + {r}_{i}^{*} \times {p}_{ij} + {t}_{i}^{*} ) ‖}^{2} \\ {Δ}^{*} ∈ nullspace \{ φ \}\end{matrix} \\ Δ = {[ {[ {r}_{1} ]}^{t} , {[ {t}_{1} ]}^{t} , … , {[ {r}_{N} ]}^{t} , {[ {t}_{N} ]}^{t} ]}^{t} \\ {Δ}^{*} = {[ {[ {r}_{1}^{*} ]}^{t} , {[ {t}_{1}^{*} ]}^{t} , … , {[ {r}_{N}^{*} ]}^{t} , {[ {t}_{N}^{*} ]}^{t} ]}^{t} \qquad ( 12 )$$

When the target function of Equation (12) is expanded, the following Equation (13) is obtained.

$$\begin{matrix}objective = {argmin}_{{Δ}^{*}} {\sum }_{i} {\sum }_{j} {‖ [ - {( {p}_{ij} )}_{X} I ] ( [ \begin{matrix}{r}_{i}^{*} \\ {t}_{i}^{*}\end{matrix} ] - [ \begin{matrix}{r}_{i} \\ {t}_{i}\end{matrix} ] ) ‖}^{2} \\ = {argmin}_{{Δ}^{*}} {\sum }_{i} {\sum }_{j} {( [ \begin{matrix}{r}_{i}^{*} \\ {t}_{i}^{*}\end{matrix} ] - [ \begin{matrix}{r}_{i} \\ {t}_{i}\end{matrix} ] )}^{t} \\ {[ - {( {p}_{ij} )}_{X} I ]}^{t} [ - {( {p}_{ij} )}_{X} I ] ( [ \begin{matrix}{r}_{i}^{*} \\ {t}_{i}^{*}\end{matrix} ] - [ \begin{matrix}{r}_{i} \\ {t}_{i}\end{matrix} ] ) \\ = {argmin}_{{Δ}^{*}} {\sum }_{i} {( [ \begin{matrix}{r}_{i}^{*} \\ {t}_{i}^{*}\end{matrix} ] - [ \begin{matrix}{r}_{i} \\ {t}_{i}\end{matrix} ] )}^{t} \\ \{ {\sum }_{j} {[ - {( {p}_{ij} )}_{X} I ]}^{t} [ - {( {p}_{ij} )}_{X} I ] \} ( [ \begin{matrix}{r}_{i}^{*} \\ {t}_{i}^{*}\end{matrix} ] - [ \begin{matrix}{r}_{i} \\ {t}_{i}\end{matrix} ] )\end{matrix} \qquad ( 13 )$$

In Equation (13), when a three-dimensional coordinate p is represented by the following equation,

$$p = [ \begin{matrix}x \\ y \\ z\end{matrix} ] ,$$

an operator (·)x in Equation (13) means generation of a 3×3 matrix represented by the following equation.

$${( p )}_{X} = [ \begin{matrix}0 & - z & y \\ z & 0 & - x \\ - y & x & 0\end{matrix} ]$$

A 6×6 matrix Cij is defined as indicated by the following Equation (14).

Cᵢⱼ=[—(pᵢⱼ)ₓ1]^{t}[—(pᵢⱼ)ₓ1] (14)

According to the definition of Equation (14), the target function is reduced as indicated by the following Equation (15).

$$\{ \begin{matrix}{{argmin}_{{Δ}^{*}} ( {Δ}^{*} - Δ )}^{t} C ( {Δ}^{*} - Δ ) \\ {Δ}^{*} ∈ nullspace \{ φ \}\end{matrix} \qquad ( 15 )$$

Here, C in Equation (15) is a 6N×6N matrix indicated by the following Equation (16).

$$C = {[ \begin{matrix}{\sum }_{j = 1}^{3} {C}_{1 j} & … & 0 \\ ⋮ & ⋱ & ⋮ \\ 0 & … & {\sum }_{j = 1}^{3} {C}_{Nj}\end{matrix} ]}_{6 N \times 6 N} \qquad ( 16 )$$

The target function indicated by Equation (15) can be solved in the same manner as the method disclosed in the reference document. (6N−3M) 6N-dimensional basis vectors (v1, v2, . . . , vK) (K=1, . . . , 6N−3M) in the null space of the joint constraint matrix φ are extracted according to an SVD algorithm. Since the motion vector Δ* belongs to the null space of the joint constraint matrix φ, the motion vector Δ* is represented as indicated by the following Equation (17):

Δ*=λ1v1+λ2v2+ . . . +λKvK (17)

If a vector δ=(λ1, λ2, . . . , λK)t and a 6N×(6N−3M) matrix V=[v1 v2 . . . vK] generated by arranging the extracted basis vectors in the null space of the joint constraint matrix φ for 6N dimensions along a row are defined, Equation (17) is changed as indicated by the following Equation (18).

Δ*=Vδ (18)

If Δ*=Vδ indicated by Equation (18) is substituted in (Δ*−Δ)tC(Δ*−Δ) in the target function indicated by Equation (15), the following Equation (19) is obtained:

(Vδ−Δ)tC(Vδ−Δ) (19)

When a difference in Equation (19) is set to 0, the vector δ is represented by the following Equation (20).

δ=(VtCV)−1VtCΔ (20)

Therefore, on the basis of Equation (18), the optimum motion vector Δ* that minimizes the target function is represented by the following Equation (21). By using Equation (21), it is possible to calculate the optimum motion vector Δ* with the joint constraint from the motion vector Δ without the joint constraint.

Δ*=V(VtCV)−1VtCΔ (21)

The reference document discloses Equation (22) as a formula for calculating the optimum motion vector Δ* with the joint constraint from the motion vector Δ without the joint constraint.

Δ*=V(VtΣ−1V)−1V)−1VtΣ−1A (22)

Here, Σ−1 is a correlation matrix of ICP.

When Equation (21) corresponding to this embodiment and Equation (22) described in the reference document are compared, in appearance, a difference between the formulas is only that Σ−1 is replaced with C. However, Equation (21) corresponding to this embodiment and Equation (22) corresponding to the reference document are completely different in the ways of thinking in processes for deriving the formulas.

In the case of the reference document, a target function for minimizing a Mahalanobis distance between the motion vector Δ* belonging to the zero space of the joint constraint matrix φ and the motion vector Δ is calculated. The correlation matrix Σ−1 of ICP is calculated on the basis of a correlation among respective quantities of the motion vector Δ.

On the other hand, in the case of this embodiment, a target function for minimizing a difference between a posture of the three-dimensional body after transformation by the motion vector Δ and a posture of the three-dimensional body after transformation by the motion vector Δ* is derived. Therefore, in Equation (21) corresponding to this embodiment, since the ICP register method is not used, it is possible to stably determine a projecting direction without relying on three-dimensional restoration accuracy. A method of photographing a frame image is not limited. It is possible to reduce a computational amount compared with the case of the reference document in which the ICP register method is used.

The second representation method for representing motions of respective parts of a three-dimensional body is explained below.

In the second representation method, postures of the respective parts of the three-dimensional body are represented by a starting point in a world coordinate system (the origin in a relative coordinate system) and rotation angles around respective x, y, and z axes of the world coordinate system. In general, rotation around the x axis in the world coordinate system is referred to as Roll, rotation around the y axis is referred to as Pitch, and rotation around the z axis is referred to as Yaw.

In the following explanation, a starting point in a world coordinate system of a part “i” of the three-dimensional body is represented as (xi, yi, zi) and rotation angles of Roll, Pitch, and Yaw are represented as αi, βi, and γi, respectively. In this case, a posture of the part “i” is represented by one six-dimensional vector shown below.
[αi, βi, γi, xi, yi, zi]t

In general, a posture of a rigid body is represented by a Homogeneous transformation matrix (hereinafter referred to as H-matrix or transformation matrix), which is a 4×4 matrix. The H-matrix corresponding to the part “i” can be calculated by applying the starting point (xi, yi, zi) in the world coordinate system and the rotation angles αi, βi, and γi (rad) of Roll, Pitch, and Yaw to the following Equation (23):

$$G ( {α}_{i} , {β}_{i} , {γ}_{i} , {x}_{i} , {y}_{i} , {z}_{i} ) = [ \begin{matrix}1 & 0 & 0 & {x}_{i} \\ 0 & 1 & 0 & {y}_{i} \\ 0 & 0 & 1 & {z}_{i} \\ 0 & 0 & 0 & 1\end{matrix} ] [ \begin{matrix}cos {γ}_{i} & - sin {γ}_{i} & 0 & 0 \\ sin {γ}_{i} & cos {γ}_{i} & 0 & 0 \\ 0 & 0 & 1 & 0 \\ 0 & 0 & 0 & 1\end{matrix} ] [ \begin{matrix}cos {β}_{i} & 0 & sin {β}_{i} & 0 \\ 0 & 1 & 0 & 0 \\ - sin {β}_{i} & 0 & cos {β}_{i} & 0 \\ 0 & 0 & 0 & 1\end{matrix} ] [ \begin{matrix}1 & 0 & 0 & 0 \\ 0 & cos {α}_{i} & - sin {α}_{i} & 0 \\ 0 & sin {α}_{i} & cos {α}_{i} & 0 \\ 0 & 0 & 0 & 1\end{matrix} ] \qquad ( 23 )$$

In the case of a rigid body motion, a three-dimensional position of an arbitrary point X belonging to the part “i” in a frame image Fn can be calculated by the following Equation (24) employing the H-matrix.

Xn=Pi+G(dαi, dβi, dγi, dxi, dyi, dzi)·(Xn−1−Pi) (24)

G(dαi, dβi, dγi, dxi, dyi, dzi) is a 4×4 matrix obtained by calculating motion change amounts dαi, dβi, dγi, dxi, dyi, and dzi of the part “i” between continuous frame images Fn−1 and Fn with a tracking method employing a particle filter or the like and substituting a result of the calculation in Equation (23). Pi=(xi, yi, zi)t is a starting point in the frame image Fn−1 of the part “i”.

If it is assumed that “a movement amount of the rigid body between the continuous frame images Fn−1 and Fn is small” with respect to Equation (24), since change amounts of the respective rotation angles are very small, approximation of sin x≡x, cos x=−1 holds. Further, secondary and subsequent terms of the polynomial are 0 and can be omitted. Therefore, the transformation matrix G(dαi, dβi, dγi, dxi, dyi, dzi) in Equation (24) is approximated as indicated by the following Equation (25).

$$G ( d {α}_{i} , d {β}_{i} , d {γ}_{i} , d {x}_{i} , d {y}_{i} , d {z}_{i} ) = [ \begin{matrix}1 & - d {γ}_{i} & d {β}_{i} & d {x}_{i} \\ d {γ}_{i} & 1 & - d {α}_{i} & d {y}_{i} \\ - d {β}_{i} & d {α}_{i} & 1 & d {z}_{i} \\ 0 & 0 & 0 & 1\end{matrix} ] \qquad ( 25 )$$

As it is evident from Equation (25), a rotation portion (upper left 3×3) of the transformation matrix G takes a form of unit matrix+outer product matrix. Equation (24) is transformed into the following Equation (26) by using this form.

$${X}^{n} = {P}_{i} ( {X}^{n - 1} - {P}_{i} ) + [ \begin{matrix}d {α}_{i} \\ d {β}_{i} \\ d {γ}_{i}\end{matrix} ] \times ( {X}^{n - 1} - {P}_{i} ) + [ \begin{matrix}d {x}_{i} \\ d {y}_{i} \\ d {z}_{i}\end{matrix} ] \qquad ( 26 )$$

Further,

$$[ \begin{matrix}d {α}_{i} \\ d {β}_{i} \\ d {γ}_{i}\end{matrix} ]$$

in Equation (26) is replaced with ri and

$$[ \begin{matrix}d {x}_{i} \\ d {y}_{i} \\ d {z}_{i}\end{matrix} ]$$

is replaced with ti, Equation (26) is reduced as indicated by the following Equation (27):

Xn=Xn−1+ri×(Xn−1−Pi)+ti (27)

The respective parts forming the three-dimensional body are coupled to the other parts by joints. For example, if the part “i” and a part “j” are coupled by a joint Jij, a condition for coupling the part “i” and the part “j” in the frame image Fn (a joint constraint condition) is as indicated by the following Equation (28).

ri×(Jij−Pi)+ti=tj−(Jij−Pi)×ri+ti−tj=0

[Jij−Pi]×·ri−ti+tj=0 (28)

An operator [·]×in Equation (28) is the same as that in Equation (13).

A joint constraint condition of an entire three-dimensional body including N parts and M joints is as explained below.

The respective M joints are represented as JK (k=1, 2, . . . , M) and indexes of two parts where the joints JK are coupled are represented by iK and jK. A 3×6N submatrix indicated by the following Equation (29) is generated with respect to the respective joints JK.

$${submatrix}_{k} ( φ ) = ( {0}_{3} … {{[ {J}_{k} - {P}_{ik} ]}^{{i}_{k}}}_{X} {- {I}_{3}}^{{i}_{k} + 1} … {{0}_{3}}^{{j}_{k}} {{I}_{3}}^{{j}_{k} + 1} … {0}_{3} ) \qquad ( 29 )$$

In Equation (29), 03 is a 3×3 null matrix and I3 is a 3×3 unit matrix.

A 3M×6N matrix indicated by the following Equation (30) is generated by arranging M 3×6N submatrixes obtained in this way along a column. This matrix is the joint constraint matrix φ.

$$φ = [ \begin{matrix}{submatrix}_{1} ( φ ) \\ {submatrix}_{2} ( φ ) \\ ⋮ \\ {submatrix}_{M} ( φ )\end{matrix} ] \qquad ( 30 )$$

Like Equation (9), if ri and ti indicating a change amount between the frame images Fn−1 and Fn of the three-dimensional body are arranged in order to generate a 6N-dimensional motion vector Δ, the following Equation (31) is obtained.

Δ=[[r₁]^{t}, [t₁]^{t}, . . . , [r_{N}]^{t}, [t_{N}]^{t}]^{t} (31)

Therefore, a joint constraint condition of the three-dimensional body is represented by the following Equation (32).

φΔ=0 (32)

Equation (32) means that, mathematically, the motion vector Δ is included in the null space {φ} of the joint constraint matrix φ. This is represented by the following Equation (33).

Δεnull space {φ} (33)

If arbitrary three points not present on the same straight line in the part “i” (i1, 2, . . . , N) among the N parts forming the three-dimensional body are represented as {pi1, pi2, pi3} on the basis of the motion vector Δ calculated as explained above and the joint constraint condition Equation (32), a formula same as Equation (12) is obtained as a target function.

In the first representation method, motions of the three-dimensional body are represented by the spiral motion and the coordinates of the arbitrary three points not present on the same straight line in the part “i” are represented by an absolute coordinate system. On the other hand, in the second representation method, motions of the three-dimensional body are represented by the rotational motion with respect to the origin of the absolute coordinate system and the x, y, and z axes and the coordinates of the arbitrary three points not present on the same straight line in the part “i” are represented by a relative coordinate system having the starting point Pi of the part “i” as the origin. The first representation method and the second representation method are different in this point. Therefore, a target function corresponding to the second representation method is represented by the following Equation (34).

$$\{ \begin{matrix}{argmin}_{{Δ}^{*}} {\sum }_{i = 1}^{N} {\sum }_{j = 1}^{3} {‖ \begin{matrix}{p}_{ij} - {p}_{i} + {r}_{i} \times ( {p}_{ij} - {P}_{i} ) + \\ {t}_{i} - ( {p}_{ij} - {P}_{i} + {r}_{i}^{*} \times ( {p}_{ij} - {P}_{i} ) + {t}_{i}^{*} )\end{matrix} ‖}^{2} \\ {Δ}^{*} ∈ nullspace \{ φ \}\end{matrix} \\ Δ = {[ {[ {r}_{1} ]}^{t} , {[ {t}_{1} ]}^{t} , … , {[ {r}_{N} ]}^{t} , {[ {t}_{N} ]}^{t} ]}^{t} \\ {Δ}^{*} = {[ {[ {r}_{1}^{*} ]}^{t} , {[ {t}_{1}^{*} ]}^{t} , … , {[ {r}_{N}^{*} ]}^{t} , {[ {t}_{N}^{*} ]}^{t} ]}^{t} \qquad ( 34 )$$

A process of expanding and reducing the target function represented by Equation (34) and calculating the optimum motion vector Δ* is the same as the process of expanding and reducing the target function and calculating the optimum motion vector Δ* corresponding to the first representation method (i.e., the process for deriving Equation (21) from Equation (12)). However, in the process corresponding to the second representation method, a 6×6 matrix Cij indicated by the following Equation (35) is defined and used instead of the 6×6 matrix Cij (Equation (14)) defined in the process corresponding to the first representation method.

Cᵢⱼ=[—[pᵢⱼ−Pᵢ]ₓ1]^{t}·[—[pᵢⱼ−Pᵢ]ₓ1] (35)

The optimum motion vector Δ* corresponding to the second representation method is finally calculated as Δ*=[da0*, dp0*, dy0*, dx0*, dy0*, dz0*, . . . ]t, which is exactly a motion parameter. Therefore, the optimum motion vector Δ* can be directly used for generation of a three-dimensional body in the next frame image.

An image processing apparatus that uses Equation (21) corresponding to this embodiment for the three-dimensional body tracking and generating the three-dimensional body image B1 from the frame images F0 and F1, which are temporally continuously photographed, as shown in FIGS. 13A to 13E is explained below.

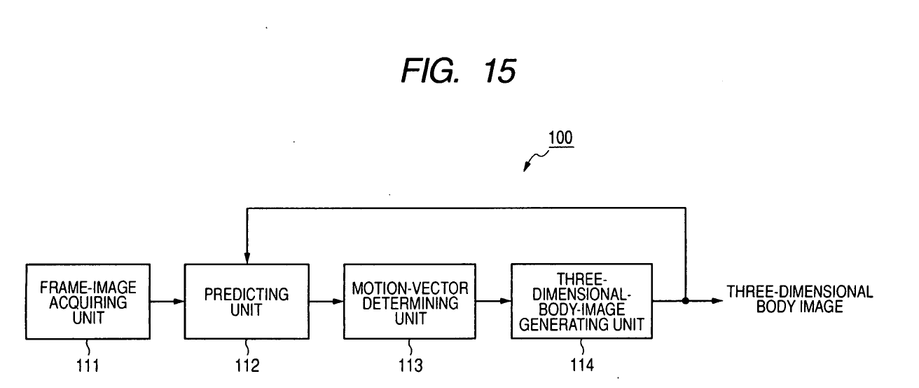

FIG. 15 is a diagram of a configuration example of the detecting unit 22A (the detection-signal processing unit 22b) corresponding to the three-dimensional body tracking corresponding to this embodiment.

The detecting unit 22A includes a frame-image acquiring unit 111 that acquires a frame image photographed by a camera (an imaging device: the detector 22a) or the like, a predicting unit 112 that predicts motions (corresponding to the motion vector Δ without the joint constraint) of respective parts forming a three-dimensional body on the basis of a three-dimensional body image corresponding to a preceding frame image and a present frame image, a motion-vector determining unit 113 that determines the motion vector Δ* with the joint constraint by applying a result of the prediction to Equation (21), and a three-dimensional-body-image generating unit 114 that generates a three-dimensional body image corresponding to the present frame by transforming the generated three-dimensional body image corresponding to the preceding frame image using the determined motion vector Δ* with the joint constraint.

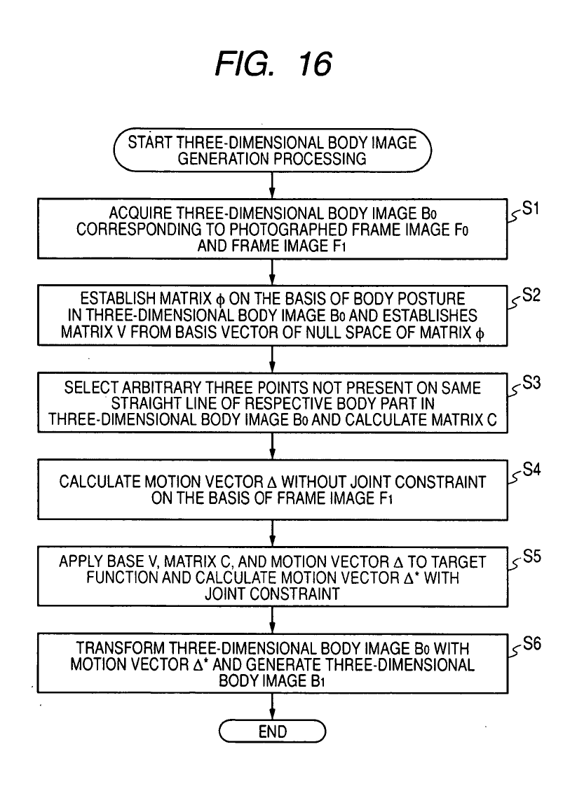

Three-dimensional body image generation processing by the detecting unit 22A shown in FIG. 15 is explained below with reference to a flowchart of FIG. 16. Generation of the three-dimensional body image E1 corresponding to the present frame image F1 is explained as an example. It is assumed that the three-dimensional body image B0 corresponding to the preceding frame image F0 is already generated.

In step S1, the frame-image acquiring unit 111 acquires the photographed present frame image F1 and supplies the present frame image F1 to the predicting unit 12. The predicting unit 12 acquires the three-dimensional body image B0 corresponding to the preceding frame image F0 fed back from the three-dimensional-body-image generating unit 114.

In step S2, the predicting unit 112 establishes, on the basis of a body posture in the fed-back three-dimensional body image B0, a 3M×6N joint constraint matrix φ including joint coordinates as elements. Further, the predicting unit 112 establishes a 6N×(6N-3M) matrix V including a basis vector in the null space of the joint constraint matrix φ as an element.

In step S3, the predicting unit 112 selects, concerning respective parts of the fed-back three-dimensional body image B0, arbitrary three points not present on the same straight line and calculates a 6N×6N matrix C.

In step S4, the predicting unit 112 calculates the motion vector Δ without the joint constraint of the three-dimensional body on the basis of the three-dimensional body image B0 and the present frame image F1. In other words, the predicting unit 112 predicts motions of the respective parts forming the three-dimensional body. A representative method such as the Kalman filter, the Particle filter, or the Interactive Closest Point method generally known in the past can be use.

The matrix V, the matrix C, and the motion vector Δ obtained in the processing in steps S2 to S4 are supplied from the predicting unit 112 to the motion-vector determining unit 113.

In step S5, the motion-vector determining unit 113 calculates the optimum motion vector Δ* with the joint constraint by substituting the matrix V, the matrix C, and the motion vector Δ supplied from the predicting unit 112 in Equation (21) and outputs the motion vector Δ* to the three-dimensional-body-image generating unit 114.

In step S6, the three-dimensional-body-image generating unit 114 generates the three-dimensional body image B1 corresponding to the present frame image F1 by converting the generated three-dimensional body image B0 corresponding to the preceding frame image F0 using the optimum motion vector Δ* input from the motion-vector determining unit 113. The generated three-dimensional body image B1 is output to a post stage and fed back to the predicting unit 12.

The processing for integrated tracking according to this embodiment explained above car be realized by hardware based on the configuration shown in FIG. 1, FIGS. 5A and 5B to FIG. 12, and FIG. 15. The processing can also be realized by software. In this case, both the hardware and the software can be used to realize the processing.

When the necessary processing in integrated tracking is realized by the software, a computer apparatus (a CPU) as a hardware resource of the integrated tracking system is caused to execute a computer program configuring the software. Alternatively, a computer apparatus such as a general-purpose personal computer is caused to execute the computer program to give a function for executing the necessary processing in integrated tracking to the computer apparatus.

Such a computer program is written in a ROM or the like and stored therein. Besides, it is also conceivable to store the computer program in a removable recording medium and then install (including update) the computer program from the storage medium to store the computer program in a nonvolatile storage area in the microprocessor 17. It is also conceivable to make it possible to install the computer program through a data interface of a predetermined system according to control from another apparatus as a host. Further, it is conceivable to store the computer program in a storage device in a server or the like on a network and then give a network function to an apparatus as the integrated tracking system to allow the apparatus to download and acquire the computer program from the server or the like.

The computer program executed by the computer apparatus may be a computer program for performing processing in time series according to the order explained in this specification or may be a computer program for performing processing in parallel or at necessary timing such as when the computer program is invoked.

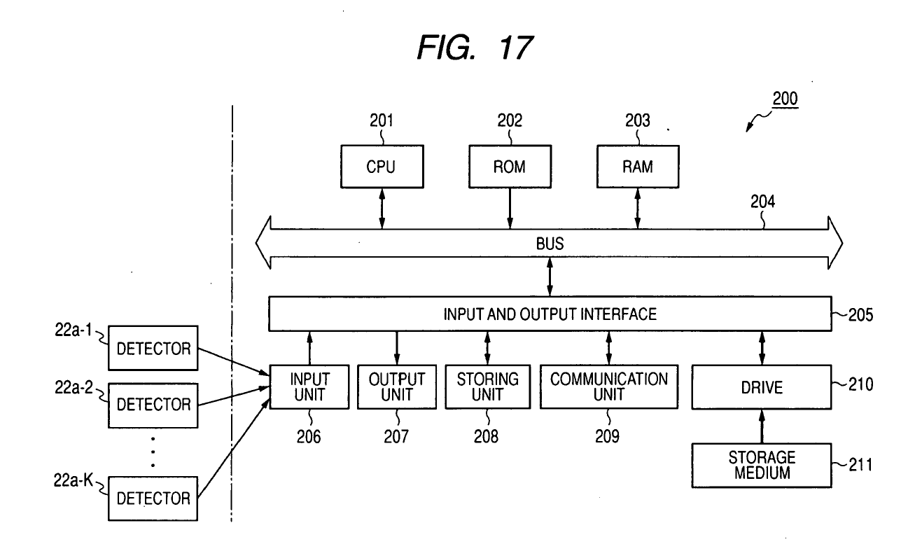

A configuration example of a computer apparatus as an apparatus that can execute the computer program corresponding to the integrated tracking system according to this embodiment is explained with reference to FIG. 17.

In this computer apparatus 200, a CPU (Central Processing Unit) 201, a ROM (ReadOnlyMemory) 202, and a RAM (Random Access Memory) 203 are connected to one another by a bus 204.

An input and output interface 205 is connected to the bus 204.

An input unit 206, an output unit 207, a storing unit 208, a communication unit 209, and a drive 210 are connected to the input and output interface 205.

The input unit 206 includes operation input devices such as a keyboard and a mouse.

In association with the integrated tracking system according to this embodiment, the input unit 20 in this case can input detection signal output from the detectors 22a-1, 22a-2, . . . , and 22a-K provided, for example, for each of the plural detecting unit 22.

The output unit 207 includes a display and a speaker.

The storing unit 208 includes a hard disk and a nonvolatile memory.

The communication unit 209 includes a network interface.

The drive 310 drives a recording medium 211 as a magnetic disk, an optical disk, a magneto-optical disk, or a semiconductor memory.

In the computer 200 configured as explained above, the CPU 201 loads, for example, a computer program stored in the storing unit 208 to the RAM 203 via the input and output interface 205 and the bus 204 and executes the computer program, whereby the series of processing explained above is performed.

The computer program executed by the CPU 201 is provided by being recorded in the recording medium 211 as a package medium including a magnetic disk (including a flexible disk), an optical disk (a CD-ROM (Compact Disc-Read Only Memory), a DVD (Digital Versatile Disc), etc.), a magneto-optical disk, a semiconductor memory, or the like or provided via a wired or wireless transmission medium such as a local area network, the Internet, or a digital satellite broadcast.

The computer program can be installed in the storing unit 208 via the input and output interface 205 by inserting the recording medium 211 into the drive 210. The computer program can be received by the communication unit 209 via the wired or wireless transmission medium and installed in the storing unit 208. Besides, the computer program can be installed in the ROM 202 or the storing unit 208 in advance.

The probability distribution unit 21 shown in FIGS. 5A and 5B and FIG. 7 obtains a probability distribution based on the Gaussian distribution. However, the probability distribution unit 21 may be configured to obtain a distribution by a method other than the Gaussian distribution.

A range in which the integrated tracking system can be applied according to this embodiment is not limited to the person posture, the person movement, the vehicle movement, the flying object movement, and the like explained above. Other objects, events, and phenomena can be tracking targets. As an example, a change in color in a certain environment can also be tracked.

It should be understood by those skilled in the art that various modifications, combinations, sub-combinations, and alterations may occur depending on design requirements and other factors insofar as they are within the scope of the appended claims or the equivalents thereof.

What is claimed is:

1. A tracking processing apparatus comprising:
first state-variable-sample-candidate generating means for generating state variable sample candidates at first present time on the basis of main state variable probability distribution information at preceding time;
plural detecting means each for performing detection concerning a predetermined detection target related to a tracking target;
sub-information generating means for generating sub-state variable probability distribution information at present time on the basis of detection information obtained by the plural detecting means;
second state-variable-sample-candidate generating means for generating state variable sample candidates at second present time on the basis of the sub-state variable probability distribution information at the present time;
state-variable-sample acquiring means for selecting state variable samples out of the state variable sample candidates at the first present time and the state variable sample candidates at the second present time at random according to a predetermined selection ratio set in advance; and
estimation-result generating means for generating main state variable probability distribution information at the present time as an estimation result on the basis of likelihood calculated on the basis of the state variable samples and an observation value at the present time.

2. A tracking processing apparatus according to claim 1, wherein the sub-information generating means obtains the sub-state variable probability distribution information at the present time from a mixed distribution based on plural kinds of detection information obtained from the plural detecting means.

3. A tracking processing apparatus according to claim 2, wherein the sub-information generating means changes a mixing ratio corresponding to the plural kinds of detection information in the mixed distribution on the basis of reliability concerning the detection information of the detecting means.

4. A tracking processing apparatus according to claim 1 or 3, wherein
the sub-information generating means obtains plural kinds of sub-state variable probability distribution at the present time corresponding to the respective plural detection information by performing probability distribution for each of the plural kinds of detection information obtained by the plural detecting means, and
the state-variable-sample acquiring means selects, according to a predetermined selection ratio set in advance, state variable samples at random from the state variable sample candidates at the first present time and the state variable sample candidates at the second present time corresponding to the sub-state variable probability distribution information at the present time.

5. A tracking processing apparatus according to claim 4, wherein the state-variable-sample acquiring means changes the selection ratio among the state variable sample candidates at the second preset time on the basis of reliability concerning detection information of the detecting means.

6. A tracking processing method comprising the steps of:
generating state variable sample candidates at first present time on the basis of main state variable probability distribution information at preceding time;
generating sub-state variable probability distribution information at present time on the basis of detection information obtained by detecting means that each performs detection concerning a predetermined detection target related to a tracking target;
generating state variable sample candidates at second present time on the basis of the sub-state variable probability distribution information at the present time;
selecting state variable samples out of the state variable sample candidates at the first present time and the state variable sample candidates at the second present time at random according to a predetermined selection ratio set in advance; and
generating main state variable probability distribution information at the present time as an estimation result on the basis of likelihood calculated on the basis of the state variable samples and an observation value at the present time.

7. A computer program for causing a tracking processing apparatus to execute:
a first state-variable-sample-candidate generating step of generating state variable sample candidates at first present time on the basis of main state variable probability distribution information at preceding time;
a sub-information generating step of generating sub-state variable probability distribution information at present time on the basis of detection information obtained by detecting means that each performs detection concerning a predetermined detection target related to a tracking target;
a second state-variable-sample-candidate generating step of generating state variable sample candidates at second present time on the basis of the sub-state variable probability distribution information at the present time;
a state-variable-sample acquiring step of selecting state variable samples out of the state variable sample candidates at the first present time and the state variable sample candidates at the second present time at random according to a predetermined selection ratio set in advance; and
an estimation-result generating step of generating main state variable probability distribution information at the present time as an estimation result on the basis of likelihood calculated on the basis of the state variable samples and an observation value at the present time.

8. A tracking processing apparatus comprising:
a first state-variable-sample-candidate generating unit configured to generate state variable sample candidates at first present time on the basis of main state variable probability distribution information at preceding time;
plural detecting units each configured to perform detection concerning a predetermined detection target related to a tracking target;
a sub-information generating unit configured to generate sub-state variable probability distribution information at present time on the basis of detection information obtained by the plural detecting units;
a second state-variable-sample-candidate generating unit configured to generate state variable sample candidates at second present time on the basis of the sub-state variable probability distribution information at the present time;
a state-variable-sample acquiring unit configured to select state variable samples out of the state variable sample candidates at the first present time and the state variable sample candidates at the second present time at random according to a predetermined selection ratio set in advance; and
an estimation-result generating unit configured to generate main state variable probability distribution information at the present time as an estimation result on the basis of likelihood calculated on the basis of the state variable samples and an observation value at the present time.
